(19) United States
(12) Patent Application Publication
(10) Pub. No.: US 2022/0247982 A1
(43) Pub. Date: Aug. 4, 2022

(54) DISPLAY APPARATUS WITH A REDUCED POWER CONSUMPTION

(71) Applicant: SEEREAL TECHNOLOGIES S.A., Munsbach (LU)

(72) Inventors: Bo KROLL, London (GB); Norbert LEISTER, Dresden Sachsen (DE); Jacob FUGAL, Dresden (DE); Robert MISSBACH, Dresden Kreischa/OT Barenklause (DE)

(21) Appl. No.: 17/595,402

(22) PCT Filed: May 14, 2020
(86) PCT No.: PCT/EP2020/063462

§ 371 Date: Nov. 16, 2021

(30) Foreign Application Priority Data
May 16, 2019 (EP) 19174874.8

(51) Int. Cl. H04N 9/31

(52) U.S. Cl. CPC H04N 9/3152; H04N 9/3155; G06T 19/006; H04N 9/3173; H04N 9/317

(57) ABSTRACT

The invention relates to a display apparatus which comprises an illumination device for emitting light, a spatial light modulation device for modulating incident light, an optical system and a control device. The optical system is provided for generating at least one image of the spatial light modulation device as a segment, where the optical system further comprises a deflection device for directing the image of the spatial light modulation device to a defined position in the field of view of a user. The control device is coupled to the illumination device and the deflection device and embodied to switch the illumination device on the basis of a control of the deflection device.

The invention relates to a display apparatus for displaying two-dimensional and/or three-dimensional information, such as objects or scenes, which provides for low power consumption. The invention preferably relates to augmented reality (AR) display apparatuses or displays. By way of example, this includes both head-mounted displays and head-up displays. However, attention should be drawn to the fact that the invention should not be construed as restricted to such displays.

Further, the invention also relates to a method for displaying two-dimensional and/or three-dimensional information, by means of which a reduced power consumption should be brought about in the case of a display apparatus.

So-called spatial light modulators that can modulate the incident light in accordance with the required information and the information to be displayed are often used in display apparatuses for representing two-dimensional and/or three-dimensional scenes. In this context, different types of spatial light modulators, which are also referred to as SLMs, are known. By way of example, a spatial light modulator that can be used to this end is an LCoS-SLM (Liquid Crystal on Silicon), which reflects rather than transmits the incident light. LCoS-SLMs are usually very small in terms of their extent, for example with diagonals of less than 20 mm, but can have a very large number of pixels, for example 4000×2000 pixels. LCoS-SLMs exist as a commercial product for modulating both the amplitude and the phase of the light. The advantage of an LCoS-SLM is clearly its reflectivity. However, there are also minor disadvantages, such as its speed, which is limited by the reaction time of the liquid crystals in the SLM. An LCoS-SLM can achieve a frame rate of, e.g., 60 Hz, and even a few hundred hertz, for example 180 Hz or 240 Hz, in some cases. However, a frame rate greater than 500 Hz cannot be achieved.

Another type of SLM is a MEMS-SLM (micro-electromechanical mirror systems), the main advantage thereof over an LCoS-SLM being its higher speed. A further advantage lies in the modulation values, phase values or amplitude values, which are able to be set in a more stable manner and are less prone to errors than those of an LCoS-SLM. By way of example, in the case of a MEMS-SLM, the modulation values of neighboring pixels can be set independently of one another in improved fashion, while in the case of an LCoS-SLM the modulation values of neighboring pixels can undesirably influence one another. On the other hand, commercially available amplitude-modulating MEMS-SLMs are currently restricted to binary types while phase-modulating MEMS-SLMs are not currently found on the display market but instead are used, for example, in the field of lithography. Moreover, such MEMS-SLMs have a relatively small number of pixels, for example fewer than VGA (640×480 pixels).

In general, the effort and costs for manufacturing a new spatial light modulator (SLM) increase with the number of pixels. Moreover, the power consumption or current consumption in a display apparatus plays an important role. In this respect, the current consumption of the spatial light modulator must also be taken into account. A significant part of the current consumption of a spatial light modulator can be traced back to the data transmission to the pixels of the spatial light modulator. However, the power consumption also depends on the length of the data lines from the edge of the spatial light modulator to the individual pixels. A spatial light modulator that is small in size and with a lower number of pixels on average has shorter data lines and therefore usually a lower power consumption. Therefore, such a spatial light modulator can be more energy-efficient, even if it is operated at high frame rates or frame frequencies, i.e., if the same number of pixels are written per unit time, in comparison with a spatial light modulator with a large number of pixels but a lower frame rate.

The power consumption is a particularly important factor for a mobile display apparatus such as a head-mounted display which is attached to a head of an observer or user and which cannot be connected to a power supply system via a cable.

In this case, a display apparatus that facilitates the use of a spatial light modulator with a small number of pixels would be considered advantageous. On the other hand, a large number of pixels are required to generate a large field of view (FoV) with a good resolution for a head-mounted display (HMD). A typical value is 60 pixels/degree of field of view for the display of a flat two-dimensional (2D) image since this value (60 pixels/degree of field of view) corresponds to the resolution of the human eye. However, a greater number of pixels per degree of field of view is required for a holographic representation of a three-dimensional (3D) scene.

A field of view of, e.g., 60 degrees×30 degrees then requires 3600 pixels×1800 pixels to generate a flat two-dimensional image, but many more pixels, for example 15 000 pixels×7500 pixels, are required to generate a holographic image. LCoS-SLMs with a resolution of approximately 4000 pixels×2000 pixels already exist as commercial products. However, these still have significant disadvantages. A higher resolution is often achieved by using smaller pixels, for example 3 to 5 micrometers in size, which in an LCoS-SLM increases the susceptibility of the modulation values to errors, for example the undesired influence of the modulation values by neighboring pixels. If, however, larger pixels, for example 8 to 10 micrometers in size, are used, a size and weight of the LCoS-SLM still disadvantageous for the installation volume and the overall weight of a head-mounted display are obtained at the resolution of 4000×2000 pixels. The size would then also have a disadvantageous effect on the production costs of the LCoS-SLM.

By way of example, documents by the applicant, such as, e.g., WO 2018/146326 A1, WO 2019/012028 A1, WO 2018/211074 A1, WO 2019/076963A, have disclosed display apparatuses in the form of head-mounted displays, each of which comprises a light guide, a coupling device and an outcoupling device, and additional optical elements which are arranged in the light path before the light is coupled into the light guide. Head-mounted displays that do not comprise a light guide, but an arrangement of focusing means, such as, e.g., lens elements and/or curved mirror elements, are known, for example, from US 2010/0097671 or US 2013/0222384.

US 2013/0222384 describes a segmented multiple image of a spatial light modulator. In this case, a large field of view is generated by virtue of various segments being generated sequentially in time by imaging the spatial light modulator, where each instance of imaging the spatial light modulator is performed at a different position in the field of view. An arrangement of two mirrors rotated in the same sense is used for the purposes of generating the segments in one embodiment of US 2013/0222384.

While the entire field of view or at least the majority thereof is normally filled with content or information in display apparatuses such as, e.g., televisions, notebooks or tablets, or else VR (virtual reality) head-mounted displays, this is not the case for an AR (augmented reality) display apparatus or AR display. Such AR displays also are referred to as mixed-reality displays and allow a person to gaze through a transparent or semitransparent system in order to observe their physical surroundings and additionally also to see images of virtual objects, such as, e.g., text, graphics, videos, etc., which are generated in order to appear as part of the physical surroundings by way of a superimposition thereon. The showing or representation or superimposition of additional information on the natural perception or surroundings of a person is therefore referred to as augmented reality (AR). In this case, this additionally displayed information, for example specified more precisely as speed displays, temperature displays, signs, warnings, or else as assistance functions, navigation system functions, radio functions or shop displays, are overlaid into the field of view of a person without the person being adversely affected thereby in terms of their behavior or operating behavior. It is therefore important for an AR display that a user can still observe their physical surroundings in addition to the virtually generated objects. Therefore, only a small part of the physical surroundings may be concealed by the content of the objects, which is displayed to the user by the AR display. However, in comparison with applications of a display apparatus as a television or VR-HMD, an AR display requires greater brightness since the user should see the information or virtual objects at approximately the same brightness level as in the physical surroundings, even in surroundings with bright sunlight. Moreover, a low power consumption is required at the same time for an AR display as a mobile appliance, for example an AR head-mounted display (AR-HMD).

Therefore, it is an object of the present invention to provide an apparatus and a method which allow a three-dimensional representation of information. Further, the apparatus should be compact and have a low weight, and moreover be energy efficient.

According to the invention, the object is achieved by an apparatus having the features of claim 1.

According to the invention, provision is made of a display apparatus which is embodied as an AR (augmented reality) display apparatus or as an AR display, in particular. Preferably, the AR display is embodied as AR head-mounted display or as AR head-up display. The apparatus comprises an illumination device, a spatial light modulation device, an optical system and a control device. The illumination device is provided to emit light, for example substantially coherent light. The spatial light modulation device is provided to modulate light emitted by the illumination device and may comprise at least one spatial light modulator. The optical system is provided in turn for generating at least one image of the spatial light modulation device as a segment and comprises, in addition to at least one imaging element, a deflection device for directing the image of the spatial light modulation device to a defined position in the field of view of a user. The control device is coupled to the illumination device and the deflection device and embodied to control or switch the illumination device on the basis of a control of the deflection device.

The intention is to be explained in more detail on the basis of an AR display, in particular an AR head-mounted display, without however being construed as restricted to this type of display, as already explained.

An AR display is a display apparatus in which virtual information or objects are superimposed on the physical surroundings of a person or user using the AR display, and so the user can receive additional information which is or may be of use when observing their physical surroundings. By way of example, when sightseeing, information relating to a point of interest or navigation advice could be shown to the user of the display apparatus or apparatus according to the invention and this is then superimposed on the physical surroundings in the field of view of the user. To attain such a superimposition of virtual information on real information in the field of view of a user, the optical system of the display apparatus according to the invention comprises a deflection device, by means of which an image of the spatial light modulation device generated by the optical system is directed at a defined position or location in the field of view of the user in order to superimpose the demanded information or the demanded object on the physical surroundings there and display this to the user. To this end, the control device of the display apparatus according to the invention is coupled to the illumination device and to the deflection device in order to be able to appropriately control both the illumination device and the deflection device. The illumination device is controlled or switched by the control device on the basis of the control of the deflection device. This means that the deflection device of the optical system is controlled and the position in the field of view at which the virtual information or the virtual object should be displayed or represented is set.

Once the demanded position in the field of view has been reached, the illumination device is controlled by means of the control device such that the illumination device correspondingly emits light that is incident on the spatial light modulation device and an image thereof is generated by means of the optical system. This image of the spatial light modulation device is consequently directed as a segment at the defined position in the field of view of the user and overlaid on the physical surroundings in the field of view such that the user can observe the information represented thereby.

In this way, it is possible to create a display apparatus for displaying two-dimensional and/or three-dimensional information, said display apparatus comprising a small number of components and consequently being compact and having a low weight. Moreover, the display apparatus according to the invention can represent demanded information to the user in energy-efficient fashion since data for generating the virtual information to be represented are only transmitted or transferred to the spatial light modulation device, or generated by the spatial light modulation device itself, when the control device accordingly controls the illumination device to emit light. This means that a calculation of the virtual information to be displayed, for example a calculation and summation of sub-holograms to form an overall hologram to display a holographic three-dimensional information or object, or else a type of image processing such as the unsharpness of objects located away from the focus of a user for the display of a stereoscopic scene, and the displays thereof, is only implemented for those regions in the field of view in which virtual information should also be represented or displayed by means of the display apparatus according to the invention. No data are calculated or, in another embodiment, no data are calculated and transferred to the spatial light modulation device for other regions in the field of view, in which no virtual information is intended to be displayed. In this way, it is therefore possible to significantly reduce the power consumption merely for a data transfer.

The display apparatus according to the invention can consequently be advantageously embodied as an augmented reality display for combining physical surroundings and represented or shown virtual information such as two-dimensional and/or three-dimensional objects, for example. The generated at least one image of the spatial light modulation device as a segment which contains virtual information in this case only assumes a fraction of the field of view, for example 2% to 30% or else only 5% to 20%. This means that the field of view is only filled with little virtual information. Expressed differently, the represented image of the spatial light modulation device as a segment or else the represented images of the spatial light modulation device as segments do not completely fill the field of view or only form part of the field of view, and so gaps or regions in the field of view filled with the real information or allowing a user to observe their physical surroundings are present between represented virtual information, which each form a complete virtual information. An image of the spatial light modulation device as segments or else a plurality of images of the spatial light modulation device as segments together can consequently form a virtual information which in turn is separated from another represented virtual information in the field of view by a gap, through which the observer perceives the physical surroundings.

The virtual information to be represented can be generated in holographic or stereoscopic fashion. Further, the virtual information can be displayed as a two-dimensional or three-dimensional representation. Combinations of two-dimensional and three-dimensional representations are also possible. According to the invention, the term “virtual information” should not be understood to mean only the fully generated virtual information, such as an object or a scene for example, but also only some of the virtual information, such as, e.g., a part of an object or part of a scene.

Further advantageous configurations and developments of the invention arise from the further dependent claims.

In a particularly advantageous configuration of the invention, it can be provided that the optical system is provided for generating at least two images of the spatial light modulation device and for generating virtual visibility regions in accordance with the number of images of the spatial light modulation device, where the at least two images of the spatial light modulation device as segments are present in the field of view.

Advantageously, the at least two images of the spatial light modulation device as segments in the field of view can be combined with one another and/or can partly overlap one another or can be spaced apart from one another by way of a gap.

The images of the spatial light modulation device are preferably generated in the field of view in time-sequential fashion.

Generating at least two images of the spatial light modulation device and the representation thereof in the field of view of a user of the display apparatus according to the invention creates a segmented representation of the virtual information in the field of view. A large field of view or a large viewing angle can be created by combining a plurality of images of the spatial light modulation device as segments. By way of example, a certain number of segments can be used, for example more than 10 segments, more than 30 segments or else more than 50 segments, facilitating a representation of virtual information in the field of view of a user.

The number of images of the spatial light modulation device as segments can advantageously be able to be set differently in each frame between a minimum value, for example one image as a segment, and a maximum value, for example 10 to 50 images as segments, and the position of the images of the spatial light modulation device as segments in the field of view can be able to be set differently in each frame.

In this case, the determination of the number and position of the images of the spatial light modulation device as segments in the field of view is dependent on physical surroundings of a user. This means that the number and position of the images of the spatial light modulation device can be set on the basis of the real surroundings. The number and position of the displayed images of the spatial light modulation device as segments consequently is variable and adjustable depending on the demanded virtual information in the field of view.

To this end, the user or the observer observes the represented two-dimensional and/or three-dimensional information or the represented two-dimensional and/or three-dimensional object through a virtual visibility region in an observer plane.

This means a virtual visibility region is generated in the observer plane when generating each individual image of the spatial light modulation device as a segment, where all generated virtual visibility regions should arise at the same position in the observer plane and should be superimposed on one another for an eye of the observer.

According to the invention, this circumstance should be construed such that a virtual observer window is present as a virtual visibility region during a holographic generation and representation of the virtual information in an encoding direction of a hologram encoded on the spatial light modulation device and that an optimal visual region, which is also referred to as “sweet spot”, is present as a virtual visibility region in the case of a stereoscopic representation of the virtual information in the field of view. Depending on the way in which the virtual information is represented, the virtual observer window and the sweet spot consequently form, in each case or else together, a virtual visibility region in an observer plane in which a user, in particular an eye of the user, is situated for the purposes of observing the generated information.

Thus, for example, one or else more segments of three-dimensional information to be represented, which should be located in the viewing direction of the eye of a user and consequently are incident on the retina in the center of the fovea of the eye, could be generated and represented in holographic fashion. However, one or more segments of the same or a further three-dimensional information to be represented, which should not be located in the viewing direction of the eye of the user and consequently are incident on the retina of the eye but not in the center of the fovea, could be generated and represented in stereoscopic fashion.

To substantially or completely avoid a possible vergence-accommodation conflict, the individual segments for displaying the virtual information in the field of view should be generated purely in holographic fashion since this can achieve a more realistic depth representation of the reconstructed information or object in comparison with a stereoscopic representation of the virtual information.

Further, provision can be made for the at least one image of the spatial light modulation device to be an image representation of the entire spatial light modulation device or an image representation of only a portion of the spatial light modulation device.

In general, the image of the spatial light modulation device forms a segment which is superimposed on the physical surroundings or the real field of view of the user and therefore is a segment of the field of view of the user. The segment in the field of view, which segment is generated by the display apparatus according to the invention and which segment contains the virtual information, can be created by an image representation of the entire spatial light modulation device, i.e., the total area of the spatial light modulation device, so that all pixels of the spatial light modulation device contribute to the generation of the segment. Alternatively, the generated segment can also be created by an image representation of only a part or a portion of the spatial light modulation device, i.e., not all pixels of the spatial light modulation device contribute to the generation of the segment.

An individual generated segment consequently only covers or conceals a small region in the field of view of the user of the apparatus according to the invention. By way of example, an individual segment may cover a region of only approximately 3°×3° or approximately 5°×3° or approximately 7°×7° of the entire field of view, the intention not being to restrict the invention to these numerical data. By way of example, the entire field of view in this case can span a region of approximately 40°×20° or approximately 60°×30° or 60°×60°, with these numerical data not being intended to be construed as restrictive either. This also means that the number of segments that contain the virtual information and are superimposed on the physical surroundings is smaller than a number of segments that would be required should the entire field of view be constructed by segments or that would be used to generate the entire field of view by means of segments. By way of example, if the entire field of view comprises a region of approximately 60°×60° and the size of an individual segment is approximately 5°×5°, then 12×12 segments, i.e., 144 segments, would theoretically be required to be able to generate the entire field of view. However, if it were only necessary to fill approximately 15% of the field of view with virtual information, i.e., with the two-dimensional and/or three-dimensional objects for example, then depending on the size of the segments approximately only 25 to 30 segments could be chosen and be sufficient for displaying the demanded information in the field of view. Consequently, more time could be saved and a greater energy efficiency could be achieved.

In an advantageous configuration of the invention, it can be provided that the deflection device comprises at least one scanning mirror element which is movably mounted or at least one grating element.

Preferably, the apparatus according to the invention for deflecting and directing the light comprises at least one scanning mirror element. As a result of being mounted in movable fashion, the at least one scanning mirror element can move or rotate, and can direct the image generated by the spatial light modulation device as a segment at a defined position in the field of view of the user. In this way, it is possible to generate a plurality of images of the spatial light modulation device and direct these at defined positions in the field of view. A commercial scanning mirror can be used as a scanning mirror element.

In another configuration of the invention, the deflection device can comprise at least one grating element, for example a switchable grating element or a polarization-selective grating element, such as a polarization grating in combination with a polarization switch. By way of example, the deflection device can comprise a stack of grating elements with different grating periods such that 2 to the power N (2^{N}) different deflection angles can be set by different combinations of N gratings.

In a further configuration of the invention, the deflection device can also comprise a combination of at least one scanning mirror element and at least one grating element, for example a volume grating. In this case, the at least one grating element or volume grating has an angular selectivity. If the scanning mirror element is set such that light is incident on the grating element or volume grating within the angular selectivity of the latter, the light is deflected further by the grating element or volume grating. Thus, the deflection angle of the scanning mirror element is amplified by the grating element or volume grating. If the scanning mirror element is set such that light is incident on a grating element or volume grating outside of the angular selectivity of the latter, said light is not deflected by said grating element or volume grating. The scanning mirror element can be used to select one of a plurality of grating elements or volume gratings, the angular selectivity and deflection angles of which are set differently, the selected grating element or volume grating then deflecting the light further. However, the invention should not be construed as being restricted to a certain type of deflection device.

To superimpose the virtual information generated by the apparatus according to the invention on the real information in the field of view, provision can advantageously be made for the optical system to comprise at least one combiner.

Consequently, the at least one combiner combines the information from the physical surroundings of the user and the information generated by the apparatus according to the invention in the field of view of the user so that the eye of the user can see and observe both information items together in the field of view.

In one configuration of the invention, the at least one combiner can be a partly reflecting mirror element that reflects light, which emanates in the beam path from the light modulation device, at least partly in the direction of an eye of a user and that at least partly transmits ambient light.

In the case of a head-up display, the at least one combiner can be, e.g., a windshield of a means of transportation, for example a vehicle.

In another configuration of the invention, the at least one combiner can also be a light guide which in the beam path couples out light emanating from the light modulation device in the direction of an eye of a user and which at least partly transmits ambient light.

Advantageously the deflection device can be arranged between the spatial light modulation device and the combiner or between the illumination device and the spatial light modulation device.

By way of example, the deflection device and hence the at least one scanning mirror element can be arranged in a Fourier plane of the spatial light modulation device. Further, this Fourier plane is then imaged into the observer plane, in which an eye of the user is situated, by means of the optical system, the virtual visibility region, i.e., a virtual observer window or a sweet spot, being generated in said observer plane, through which the user must gaze in order to be able to observe the represented virtual information in the field of view. If the at least one scanning mirror element of the deflection device is in motion, the position of the virtual visibility region in the observer plane remains stationary, with however the generated image of the spatial light modulation device as a segment moving to the defined position in the field of view.

In a further advantageous configuration of the invention, it can be provided that the deflection device comprises two scanning mirror elements which are rotatable in a manner synchronized to one another.

It is also possible to use a combination of two scanning mirror elements for directing the image of the spatial light modulation device as a segment at a defined position in the field of view.

These scanning mirror elements can be rotated or moved in a manner synchronized to one another. As a result of this synchronized movement of the scanning mirror elements with respect to one another it is possible to likewise obtain a movement of the image of the spatial light modulation device as a segment or of the image plane of the spatial light modulation device to a defined position in the field of view without there being a change in the position of the virtual visibility region in the observer plane. The two scanning mirror elements can then be arranged in the apparatus according to the invention so that, for example, one scanning mirror element is arranged upstream of the Fourier plane of the spatial light modulation device in the light direction and the further scanning mirror element is arranged downstream of the Fourier plane in the light direction.

Likewise, provision can also be made in a further configuration of the invention for the deflection device to comprise at least two grating elements, which are both switched in a manner synchronized to one another. As a result of the synchronized switching of the two grating elements it is possible to likewise obtain a movement of the image of the spatial light modulation device as a segment or of the image plane of the spatial light modulation device to a defined position in the field of view without there being a change in the position of the virtual visibility region in the observer plane. By way of example, one grating element can be arranged upstream of the Fourier plane of the spatial light modulation device in the light direction and the further grating element can be arranged downstream of the Fourier plane in the light direction.

Preferably the at least one combiner can comprise at least one focusing element or at least one focusing function.

The at least one combiner can comprise at least one focusing element in order to direct or set the virtual information to be represented in the depth region in the field of view at the demanded depth. In this case, the focusing element is preferably embodied in such a way that it does not impair or influence the perception of the physical surroundings in the field of view. By way of example, the focusing element could be embodied as a grating element with a limited acceptance angle to this end, preferably as a volume grating with a limited acceptance angle.

In this case, the acceptance angle is matched to the angle of incidence of the information-carrying light but not to the angle of incidence range of light within which the light from the physical surroundings is incident on the grating element. As a result, the light that is incident on the grating element from the physical surroundings is not influenced by said grating element and passes through the latter unimpaired.

By way of example, the combiner can be embodied as a partly reflecting mirror or as a light guide, on the surface of which a focusing element, for example a grating element, is provided or attached.

As an alternative thereto, the at least one combiner itself can have a focusing function by virtue of having a curved or at least partly curved embodiment. Focusing of the light or of the image of the spatial light modulation device as a segment at a z-position defined (along the z-direction or along the optical axis of the optical system) using the at least one combiner can be achieved as a result of the curved embodiment of the latter. Expressed differently, the at least one combiner can be at least partly curved. By way of example, if the at least one combiner is embodied as a partly reflecting mirror element, the mirror surface can be curved or arched, for example in the form of a concave mirror, and thus have a focusing function in a configuration of the invention. Combining a curved surface with an additional grating element on this surface of the at least one combiner is also possible, for example.

Consequently, the at least one combiner could be embodied in the style of a spectacle lens or else as a windshield. In this case, it can have a flat or plane embodiment and comprise a focusing element. However, the at least one combiner could also have an at least partly curved embodiment and consequently act as a focusing element itself or be additionally combined with focusing elements.

In an advantageous configuration of the invention, it can further be provided that a continuous movement of the at least one scanning mirror element or a stepwise movement of the at least one scanning mirror element with a fixedly defined increment is provided in the deflection device.

Consequently, the at least one scanning mirror element can be moved continuously or stepwisely in order to direct the image of the spatial light modulation device as a segment at a demanded position in the field of view.

By way of example, a stepwise movement of the at least one scanning mirror element can be implemented in such a way that the scanning mirror element is moved through a defined angle and then stopped in order at this moment at this defined fixed scanning mirror element position to correspondingly control the control device of the apparatus according to the invention such that the illumination device emits light so that an image of the spatial light modulation device as a segment is generated and this segment is directed at the position in the field of view homed in on by the scanning mirror element. This means that the control device controls the illumination device only in the stop state of the scanning mirror element, and so the light emitted by said illumination device is modulated with the demanded information by means of the spatial light modulation device and an image of the spatial light modulation device is generated by means of the optical system, said image then being directed at the specified position in the field of view by the scanning mirror element. After the image of the spatial light modulation device has been generated and directed at the demanded position in the field of view, the scanning mirror element is moved through a further defined angle by means of the control device, where the scanning mirror element then is stopped in terms of its movement again so that a further image of the spatial light modulation device can be generated and can be directed to another defined position in the field of view. Such a start-stop movement of the scanning mirror element is possible at a high speed. Suitable mirror elements to this end are already known. To this end, the illumination device of the apparatus according to the invention should comprise at least one light source that can be operated in pulsed fashion. Then, the illumination device or the at least one light source is only in the activated state for as long as the scanning mirror element is in the stop state. If the scanning mirror element is in motion, the illumination device or the light source is in an OFF state.

As an alternative to a stepwise movement of the at least one scanning mirror element, the latter can also provide for a continuous movement. However, a continuous movement of the at least one scanning mirror element would also cause a continuous displacement of the generated image of the spatial light modulation device. However, this is unwanted. In order to counteract such a continuous movement of the image of the spatial light modulation device after the generation thereof, provision can advantageously be made in the case of a continuous movement of the at least one scanning mirror element for the at least one scanning mirror element to be combined with a compensation mirror element which carries out such a synchronized movement with the movement of the at least one scanning mirror element that, in the case of a movement of the two mirror elements in the same sense, an image of the spatial light modulation device is generable at a fixed unchanging position and, in the case of a movement of the two mirror elements in the opposite sense, an image of the spatial light modulation device is displaceable in the field of view. As a result of the provision of a compensation mirror element with a controllable embodiment it is possible to keep the image of the spatial light modulation device at the same demanded position during the generation thereof and consequently direct said image at a defined position in the field of view. The compensation control element can likewise be controlled by the control device. Both movements, i.e., the movement of the at least one scanning mirror element and the movement of the compensation mirror element synchronized thereto, are consequently combined with one another in order to direct an image of the spatial light modulation device as a segment at a demanded position in the field of view. By way of example, the at least one scanning mirror element could be combined with the compensation mirror element in such a way that during the continuous movement of the scanning mirror element the latter reaches a position at which an image of the spatial light modulation device should be generated but now this image of the spatial light modulation device is no longer directable at the defined position as demanded on account of the continuous movement of the scanning mirror element. In this case, the compensation mirror element is controllable such that the latter carries out a movement that is synchronized with the movement of the scanning mirror element. As a result, the generated image of the spatial light modulation device as a segment is displaced or moved in a direction counter to the movement direction of the scanning mirror element such that it can be displaced and directed at the demanded defined position in the field of view as a result of this compensation movement of the compensation mirror element. A subsequently generated image of the spatial light modulation device is directed at its defined position in the field of view in the same way. However, the synchronized movement of the compensation mirror element is only maintained by controlling of the control device for as long as the illumination device or the at least one light source is in an ON state. In other words, a movement of the scanning mirror element and of the compensation mirror element in the same sense can be provided for as long as the illumination device is in an ON state. The compensation mirror element can be moved into its initial state when the illumination device or the at least one light source is in an OFF state.

Advantageously, it can be provided that a continuous movement of the at least one scanning mirror element with different predefined speeds or a stepwise movement of the at least one scanning mirror element with different adaptable increments is provided for generating at least two images of the spatial light modulation device as segments in the field of view within a frame.

When generating two or more images of the spatial light modulation device as segments, directing the segments at the demanded defined position in the field of view by means of the at least one scanning mirror element can be carried out at different speeds in the case of a continuous movement or with different increments in the case of a stepwise movement. The speed or the increment of the movement of the at least one scanning mirror element in this case depends on the demanded position of the image to be generated of the spatial light modulation device as a segment in the field of view of the user. By way of example, should virtual information be represented or displayed in the left region of the field of view and should virtual information likewise be represented or displayed in the right region of the field of view for the user of the apparatus according to the invention, a speed defined as normal is required for directing and displaying the image of the spatial light modulation device as a segment in the left region of the field of view for example, while directing and displaying the image of the spatial light modulation device as a segment for the right region of the field of view accordingly requires a greater speed of the at least one scanning mirror element since both virtual information items are spaced far apart in the field of view but the user would like to observe these information items as simultaneously as possible. In order to ensure this, the scanning mirror element needs to be operated at a higher speed so that the image of the spatial light modulation device as a segment in the right region of the field of view can be displayed as simultaneously as possible with the image of the spatial light modulation device in the left region of the field of view. However, if virtual information were only required in the left region of the field of view and were located close together, the at least one scanning mirror element can be operated at a lower speed between the two or more representations of the virtual information. In other words, provision can advantageously be made for the speed or the increment of the movement of the at least one scanning mirror element to be adapted to the defined position of the respective image of the spatial light modulation device as segment in the field of view.

On account of aberrations which could be generated by the optical system, the size and the shape of the generated segments could vary with the position in the field of view. To correct such changes in size and changes in shape of segments in the field of view, the speed or the increment of the movement of the at least one scanning mirror element could likewise be varied accordingly.

Further, provision can be made in a further configuration of the invention for the size and/or shape of the at least one image of the spatial light modulation device as a segment to be variable in successive frames or the size and/or shape of the at least two images of the spatial light modulation device as segments with the defined position in the field of view to be variable within a frame or in successive frames.

A change in the size and/or shape of the at least one image of the spatial light modulation device as a segment in successive frames is expedient, in particular, if the size and/or shape of the represented scene or objects also changes in successive frames and should be represented with a fixed number of segments.

By way of example, if the size of an object changes so that it can be represented in one frame using a single segment but it is slightly larger than the segment in the next frame, it may be more advantageous to rather adapt the size and/or shape of the at least one image of the spatial light modulation device as a segment than represent this object by two segments of fixed size. A change in the size or shape of the at least one image of the spatial light modulation device as a segment with the defined position in the field of view within one frame can serve the same purpose but it can also be used if a higher resolution is required in certain regions of the field of view than in other regions. By way of example, segments with a small extent and a fine resolution could be generated in the central region of the field of view and segments with a large extent and a coarser resolution could be generated in the edge region of the field of view.

However, a change in the size or shape of the at least one image of the spatial light modulation device as a segment with the defined position in the field of view within one frame can also serve to simplify the optical system, for example. This accepts that in the case of a simple optical system a change in the magnification as a function of position in the field of view or changes in the optical distortions, which influence the shape of the image, may arise when the at least one image of the spatial light modulation device as a segment is generated.

In a particularly advantageous configuration of the invention, provision can be made for the at least one combiner to be embodied as a partly reflecting mirror element or as a light guide.

The at least one combiner could be embodied as a partly reflecting mirror element. By way of example, this partly reflecting mirror element could be a windshield in a means of transportation, or else a spectacle lens.

Additionally, the at least one combiner could be embodied as a light guide, where the light propagates in the light guide on account of total-internal reflection. The light guide as a combiner is part of the optical system and also serves to generate the image of the spatial light modulation device as a segment. In this case, the light from the physical surroundings of the user can pass through the light guide as combiner in unimpeded fashion, as a result of which the at least one image of the spatial light modulation device as the segment carrying the virtual information, generated by the apparatus according to the invention, is superimposed on the physical surroundings of the user in the field of view.

Advantageously, provision can be made in a configuration of the invention for the deflection device to be embodied as a switchable coupling element for coupling the light into the combiner embodied as a light guide and/or as an outcoupling element for coupling the light out of the combiner embodied as a light guide.

In a configuration of the apparatus according to the invention in which the combiner is embodied as a light guide, the deflection device for directing the image of the spatial light modulation device at a defined position in the field of view can be embodied as a switchable coupling element and/or else as a switchable outcoupling element. By way of example, a switchable outcoupling element can be used to couple light out of the light guide at different positions of the light guide and thus generate an image of the spatial light modulation device as a segment at different positions in the field of view. By way of example, a light guide as described in WO 2018/146326 A1 could be used as a light guide, the disclosure of said document being intended to be incorporated in full herein. The light propagates within the light guide by way of a reflection at the boundary surfaces of the light guide, with the coupling of the light out of the light guide being provided after a predefined number of reflections of the light of the boundary surfaces of the light guide. The light outcoupling device can be designed to be controllable, where the light outcoupling device is controllable in such a way that light is coupled out after a predefined number of reflections in a controlled state of the light outcoupling device and the light continues to propagate in the light guide in another controlled state of the light outcoupling device. Further, WO 2018/146326 A1 describes a display apparatus, in particular a near-to-eye display apparatus, which comprises an illumination device having at least one light source, at least one spatial light modulation device, an optical system and such a light guiding device. For an image representation or for an individual segment of a multiple image of the spatial light modulation device, the outcoupling of light coming from different pixels of the spatial light modulation device following entry into the light guiding device can be provided after the same number of reflections in each case at the boundary surfaces of the light guide for all pixels. For different segments of the multiple image, the number of reflections of the light at the boundary surfaces of the light guide for the generation of one segment can differ from the number of reflections of the light at the boundary surfaces of the light guide for the generation of another segment. For different segments of a multiple image, the number of reflections of the light at the boundary surfaces of the light guide can be equal and the coupling location of the light into the light guide can differ for these segments. To displace the coupling location of the light into the light guide it is possible to provide a light deflection device upstream of the light guiding device in the light direction.

In this case, the light deflection device for displacing the light coupling location and/or the outcoupling element for coupling the light out of the light guide is only controlled if an image of the spatial light modulation device as a segment is required at a position in the field of view which is connected to the location of outcoupling.

In a further configuration of the invention in which the at least one combiner is likewise embodied as a light guide, the deflection device can have the already mentioned at least one scanning mirror element.

The optical system and the light guide are embodied such that light beams emanating from the individual pixels of the spatial light modulation device are incident on, and able to be coupled into, the light guide at on average different angles relative to the surface of the light guide, as a result of which an coupling angular spectrum is definable, where the light beams propagating in the light guide are able to be coupled out of the light guide at on average different angles relative to a virtual visibility region, as a result of which an outcoupling angular spectrum is definable.

In particular, the light guide could be embodied like in WO 2019/012028 A1 in a preferred configuration of the invention, with the content of said document being intended to be incorporated in full herein. Described therein is a light guide which is embodied such that the outcoupling angular spectrum of the light is increased in comparison with the coupling angular spectrum of the light. However, the outcoupling angular spectrum and the coupling angular spectrum of the light could also be the same size in another configuration of the invention.

Preferably, the at least one scanning mirror element can then be arranged in the beam path between the spatial light modulation device and the light guide as a combiner. In this way, the coupling angle of the light into the light guide can be altered by a movement or rotation of the scanning mirror element for example, as a result of which there also is a change in the propagation angle of the light in the light guide. The light guide as a combiner can comprise passive or active outcoupling elements. By means of these outcoupling elements it is possible to accordingly couple the light out of the light guide at different positions and/or at different outcoupling angles and consequently direct said light at defined positions in the field of view.

By way of example, rather than using a spatial light modulation device having a relatively large number of pixels (e.g., more than 1000 pixels in one dimension), it would be possible to use a spatial light modulation device in conjunction with a light guide as a combiner and at least one scanning mirror element, this spatial light modulation device having a relatively small number of pixels (e.g., less than 1000 pixels in one dimension). In an apparatus according to the prior art, a spatial light modulation device with a large number of pixels would generate a certain coupling angular spectrum that would be coupled into the light guide, where the field of view obtained by the apparatus would be proportional to the coupling angular spectrum.

According to the invention, use is preferably made of a spatial light modulation device with a small number of pixels, for example several hundred pixels in one direction. This spatial light modulation device generates a small coupling angular spectrum for each segment to be generated in the field of view. The at least one scanning mirror element is embodied such that the central angle of the light to be coupled into the light guide is different in each case for each segment to be generated that contains virtual information. In this way, one and the same light guide can be used to generate images of the spatial light modulation device as segments at different positions in the field of view, virtual information being displayed for the user in said images. In this case, each generated segment has a field of view per se, which is proportional to the small coupling angular spectrum, with the combination of a plurality of segments in turn generating a large angular spectrum when considered as a whole.

There is no intention to restrict the invention to a certain type of spatial light modulation device.

Various types or combinations of more than one spatial light modulation device can likewise be used for the invention. Preferably, the spatial light modulation device can comprise an LCoS-SLM or a MEMS-SLM.

An LCoS-SLM is a spatial light modulation device that has a relatively large number of pixels but a relatively low frame rate. By contrast, a MEMS-SLM only has a small number of pixels but has a relatively high frame rate.

In respect of a spatial light modulation device with a relatively large number of pixels, the spatial light modulation device could be subdivided into virtual regions or portions. To generate an image of the spatial light modulation device as a segment containing virtual information for the user, only such a virtual region or portion of the spatial light modulation device is illuminated, and not the entire spatial light modulation device. Each pixel of the spatial light modulation device or, in another embodiment, all pixels that contribute to the representation of virtual information are assigned to at least one virtual region or portion. The virtual regions or portions can also overlap on the spatial light modulation device. In the case of overlapping virtual regions or portions, one pixel of the spatial light modulation device can also be assigned to more than one virtual region or portion. By way of example, the spatial light modulation device could be an LCoS-SLM with a pixel number of 4000×2000 pixels and as a result of subdividing the LCoS-SLM into virtual regions or portions it would be possible to generate images of these regions of the LCoS-SLM as segments with a size of 400×400 pixels by only illuminating these virtual regions or portions in each case.

For an individual image, data are written to all pixels of the spatial light modulation device or precisely only to those pixels that should contribute to representing the virtual information. In this case, writing data can be implemented by a line scan on the spatial light modulation device, for example. To generate in each case one image of the spatial light modulation device as a segment of the field of view, the virtual regions or portions of the spatial light modulation device, e.g., an LCoS, are illuminated in succession. To this end, the deflection device which comprises at least one scanning mirror element can be arranged in the beam path between the illumination device and the spatial light modulation device and can direct the light at the respective virtual regions or portions of the spatial light modulation device by a defined movement of the at least one scanning mirror element by means of the control device. To this end, the workflow for illuminating the virtual regions or portions of the spatial light modulation device can be matched to the workflow of writing the data to the pixels of the spatial light modulation device. The regions or portions of the spatial light modulation device can have the same size or else have different sizes.

In the case of a continuous movement of the at least one scanning mirror element, the virtual regions or portions of the spatial light modulation device can also have a relatively large overlap. By way of example, virtual regions or portions provided adjacent to one another can have an overlap of only one pixel or else of only a few pixels. While the spatial light modulation device is scanned, the illumination device is only in an ON state in the case of pixels or virtual regions which contribute to representing virtual information in the field of view of a user. If, as may be the case, pixels or virtual regions on the spatial light modulation device which do not contribute to representing virtual information at this time are scanned, the illumination device is in an OFF state.

However, it would also be possible to use a spatial light modulation device with only a relatively small number of pixels, for example a MEMS-SLM. In this case, the number of pixels could be below that of typical resolutions for a display apparatus or a display, for example less than 640×480 pixels (VGA), for example 200×200 pixels or 300×200 pixels or else 400×400 pixels, wherein the number of pixels of a spatial light modulation device for the apparatus according to the invention should not be construed as restricted to these disclosed numbers of pixels.

For spatial light modulation devices with a relatively small number of pixels, the deflection device can preferably be arranged in the beam path between the spatial light modulation device and the at least one combiner. In such a configuration of the invention, provision can preferably be made for an image of the spatial light modulation device as a segment to correspond to an image of the entire area of the spatial light modulation device. Therefore, all generated segments preferably have the same size. The images of the spatial light modulation device as segments are represented or displayed time-sequentially in the field of view of the user. This is implemented in each case by writing information, e.g., encoding a hologram, to the spatial light modulation device and imaging the spatial light modulation device by means of the optical system, where the respective image of the spatial light modulation device as a segment is directed at a defined, in each case different position in the field of view by means of the deflection device, for example by means of the at least one scanning mirror element.

In a particular configuration of the invention, provision can be made for the additional information in the field of view of the user of the apparatus according to the invention to be represented in stereoscopic fashion. This means that flat or plane two-dimensional images are generated and displayed, where an image of the information to be represented is generated for each of the left eye and the right eye of the user. In turn, this means that a display apparatus according to the invention should be provided for generating an image for the left eye and a display apparatus according to the invention should be provided for generating an image for the right eye of the user. The two display apparatuses according to the invention can be combined with one another, for example in the style of a pair of spectacles.

A display apparatus according to the invention can also be provided for both eyes, in such a way that for example use is made of one illumination device and one spatial light modulation device, where an optical system is provided, by means of which light is deflected to the left eye and light is deflected to the right eye of a user by time-division or space-division multiplexing.

By way of example, a separate combiner can also be assigned to each eye of the user in this case, for example a separate light guide for the left eye and a separate light guide for the right eye, where light from the spatial light modulation device is coupled into the one or the other light guide in time-sequential fashion by way of a switch-over element. In other applications, for example a head-up display, provision can also be made of a common combiner for both eyes of a user; by way of example, in that case the combiner would be the windshield of a means of transportation or vehicle.

In a further advantageous configuration of the invention, provision can be made for the optical system to comprise a variable focus system which is capable of setting the distance of the at least one image of the spatial light modulation device as a segment in the field of view from the user.

The apparatus according to the invention can have a varifocal configuration. This means that the virtual information generated in the field of view is adjustable in terms of its depth along the optical axis of the optical system of the apparatus. The depth or depth position should be understood to mean the distance of the virtual information, i.e., of the generated image of the spatial light modulation device as a segment, from the observer plane in which the user is situated with their eye. Consequently, a variable focus system of the optical system can be used to set the distance of the segment having the virtual information in accordance with a demanded depth position in the field of view.

Preferably the variable focus system can comprise at least one grating element with a controllable grating period or a combination of active and passive imaging elements. By way of example, the grating element can be a liquid crystal grating element. Additionally, the variable focus system can comprise combinations of tunable grating elements and passive imaging elements such as lens elements, for example. The variable focus system can also comprise a switchable grating element such as a switchable polarization grating, for example, or a passive grating in combination with a polarization switch.

The variable focus system is preferably arranged in the vicinity of a Fourier plane or in a Fourier plane of the spatial light modulation device, with other arrangements also being possible. The Fourier plane of the spatial light modulation device is formed in the beam path, for example between the spatial light modulation device and the at least one combiner.

If the variable focus system comprises at least one grating element with a controllable grating period, then provision can be made according to the invention for the at least one grating element with a controllable grating period to have prism functions and/or phase functions for correcting aberrations caused by the optical system.

In addition to a lens function, the at least one grating element can also have other functions, such as prism functions or phase functions, for correcting aberrations. These functions can be written to the at least one grating element.

In a particularly advantageous configuration of the invention, it can be provided that a gaze tracking system for detecting a viewing direction of the user is provided.

The provision of a gaze tracking system allows ascertainment of what the user is looking at in the field of view at a certain time or which part of the field of view and which part or object of the represented virtual information or real information in the field of view is currently of interest to the user and therefore focused on by them. Thereupon, the depth position in the z-direction of the focused-on object or objects, which are actively looked at or focused on by the user, is determined. The depth position of real information, i.e., the distance from the eye of the user, can be detected for said real information by means of an additional sensor, for example. Shown virtual information in the surroundings of, or related in terms of content to, the focused-on real information in the field of view or other important virtual information, for example warnings, should then be represented for example at the same depth as the real information focused on by the user. Using the variable focus system it is possible to displace the depth position of the image of the spatial light modulation device as a segment to that depth position along the z-direction which is currently actively focused on by the user. The virtual information in the field of view not focused on or gazed at by the user could be influenced in such a way by means of software systems that this information would be represented, e.g., in slightly out of focus or slightly blurry or distorted fashion or may optionally not be displayed at all.

Moreover, in addition or as an alternative to the gaze tracking system, provision can be made of a detection device for ascertaining the region of the field of view in which virtual information should be represented.

In the field of view of a user, the detection device ascertains the region of the field of view in which one or else more virtual information items should be generated and displayed or represented.

The illumination device of the display apparatus according to the invention can comprise at least one light source that is controllable in pulsed fashion.

Further, the object of the invention is also achieved by a method having the features of claim 28.

The method according to the invention has the following features:
controlling a control device which is coupled to an illumination device for emitting light and to a deflection device of an optical system of a display apparatus, for operating the illumination device on the basis of a control of the deflection device in order to direct at least one image of a spatial light modulation device as segment to a defined position in the field of view of a user,
directing the light at the spatial light modulation device and generating at least one image of the spatial light modulation device as a segment by the optical system,
directing the image of the spatial light modulation device as a segment by the deflection device to the defined position in the field of view of the user, and
representing virtual information in the segment in the field of view of the user.

The method according to the invention facilitates an energy-efficient representation of information in a field of view of a user since information is only represented and displayed to the user when required.

Preferably, the detection device can be used to determine, for each frame of an image sequence intended to be represented by means of a display apparatus, which part or region of the field of view should be filled or displayed with virtual information, for example with two-dimensional and/or three-dimensional objects or scenes, and which part or region of the field of view should contain no virtual information.

In this case, the optical system can be used to generate at least two images of the spatial light modulation device and virtual visibility regions corresponding to the number of images of the spatial light modulation device, where the at least two images of the spatial light modulation device as segments are formed in the field of view of the user, preferably are combined with one another or made to overlap one another or are spaced apart by a gap.

Advantageously, at least one combiner of the optical system can superimpose real information in the field of view on virtual information additionally generated in the field of view by displaying the at least one image of the spatial light modulation device as a segment.

The at least one image of the light modulation device as a segment can be generated in accordance with a demanded position in the field of view. The at least one image of the spatial light modulation device can be generated dynamically for each frame, in such a way that the generated image of the spatial light modulation device as a segment depends on the position of the virtual information to be represented in the field of view for the respective frame. In this case, the images of the spatial light modulation device as segments can be generated in such a way in particular that, for an individual frame or for an individual image, the virtual information in the form of objects is located within a minimum number of images of the spatial light modulation device as segments. That is to say, to represent virtual information in the form of navigation advice for example, e.g., only three images of the spatial light modulation device as segments are required. However, to represent a different object as virtual information, seven images of the spatial light modulation device as segments for example may be required. Consequently, the number of images, to be generated, of the spatial light modulation device required to represent virtual information in the form of an object also depends on the size of the object to be displayed. By way of example, for virtual information in the form of an object where the object is smaller than the extent of the image of the spatial light modulation device in terms of its size, the image of the spatial light modulation device can be generated in such a way that the entire object is generated by only one image of the spatial light modulation device as a segment and represented in the field of view. To this end, the center of the object can coincide with the center of the image of the spatial light modulation device as a segment, for example.

In a configuration of the invention, provision can be made for the field of view to be subdivided into grid fields, where a check is carried out for each frame in respect of in which grid field of the field of view virtual information should be represented, where the spatial light modulation device and at least one scanning mirror element of the deflection device are controlled in such a way that an image of the spatial light modulation device as a segment is generated, in each case only for the grid field in which the virtual information should be represented for each frame, and directed at the defined position in the field of view.

The field of view can be embodied in the style of a grid arrangement that has a plurality of grid fields. This grid arrangement can be fixedly defined and therefore be the same for each frame. The number of segments to be generated as images of the spatial light modulation device for representing virtual information is however smaller than the overall number of segments required to generate the entire field of view. In this configuration of the invention the time to generate an individual image of the spatial light modulation device as a segment is 1/M of the overall image time, where M is the number of segments containing the virtual information. In the already mentioned example of a field of view of 60°×60°, in which 144 segments would have to be generated in order to generate the entire field of view, the number of segments as images of the spatial light modulation device that each contain virtual information would be M=30. In turn, this would allow controlling the spatial light modulation device at a lower frame rate. However, it would require the optical system to have a more flexible configuration. By way of example, the images of the spatial light modulation device as segments could be generated or might have to be generated at different positions in the field of view with gaps or distances therebetween. In this case, the size of the gaps or distances can be different from frame to frame in each case. Consequently, this depends on the respective positions of the segments in the field of view so that a segment in the left field of view region is able to be generated in a manner spaced apart by a relatively large gap from a segment in the right field of view region. To this end, a scanning mirror element of the deflection device would have to be moved at different speeds, for example, in order to bridge the gaps of different sizes. The number of segments M that contain virtual information can also vary from frame to frame.

In an alternative configuration of the invention, provision can be made for the field of view to be subdivided into grid fields, where each grid field is scanned in succession by at least one scanning mirror element of the deflection device, where a check is carried out for each frame in respect of in which grid field of the field of view virtual information should be represented and a virtual information-containing image of the spatial light modulation device as a segment is generated and assigned by the optical system only to the respective grid field in which the virtual information should also be represented.

The field of view can also be embodied in the style of a grid arrangement that has a plurality of grid fields in this alternative embodiment. This grid arrangement can be fixedly defined and therefore be the same for each frame. The number of segments to be generated as images of the spatial light modulation device for representing virtual information is also smaller than the overall number of segments required to generate the entire field of view. However, in this case all grid fields of the grid arrangement are scanned in succession, where, however, an image of the spatial light modulation device is only generated by controlling the illumination device, the spatial light modulation device and the deflection device if virtual information should be represented in the respective grid field to be currently scanned. The individual images of the spatial light modulation device as segments, in which virtual information should be displayed, are generated time-sequentially. The time for generating an individual image of the spatial light modulation device as a segment is 1/N of the overall image time, where N is the overall number of segments, in this configuration of the invention.

The illumination device is consequently not controlled for grid fields in which no virtual information should be represented, and so no image of the spatial light modulation device is generated. Consequently, no data are transferred to the spatial light modulation device either, as a result of which the data transfer is reduced. Should the illumination device nevertheless be activated, it would also be possible in all pixels assigned to a grid field in which no virtual information should be displayed for there to be a global reset to a level in which the liquid crystal layer of the spatial light modulation device is controlled in such a way that the liquid crystals move back into a type of initial state. A further option would consist of switching these pixels into an undefined state.

The at least one scanning mirror element of the deflection device can be moved continuously or stepwise with a defined increment for directing the at least one image of the spatial light modulation device as a segment to a defined position in the field of view.

In the case of a stepwise movement of the at least one scanning mirror element, provision can be made for the illumination device to be activated in each case when the at least one scanning mirror element is in a holding state or in a stop state following a defined increment and the spatial light modulation device is illuminated for generating an image of the spatial light modulation device, as a result of which the generated image of the spatial light modulation device as a segment is directed at a defined position in the field of view. The illumination device is deactivated when the at least one scanning mirror element is in a movement state.

The illumination device is consequently controlled in conjunction with the control of the deflection device, in particular the at least one scanning mirror element, and brought into an ON state and into an OFF state depending on whether the at least one scanning mirror element is in a stop state or in motion. The illumination device and the deflection device are controlled by the control device in this case.

In the case of a continuous movement of the at least one scanning mirror element, a compensation mirror element can be combined with the at least one scanning mirror element, where the compensation mirror element carries out a movement that is synchronized with, preferably in the same sense as, the at least one scanning mirror element when the illumination device is in an ON state.

The synchronized movement of the compensation mirror element for moving the at least one scanning mirror element is only carried out if the illumination device is in an ON state or activated. In this configuration of the invention according to the invention, too, the illumination device is coupled to the deflection device, where the deflection device also comprises the compensation mirror element in addition to the at least one scanning mirror element. It would also be possible for the compensation mirror element to not be a constituent part of the deflection device. Should this be the case, the illumination device is coupled not only to the deflection device but additionally also to the compensation mirror element. In turn, the control device controls the illumination device and the deflection device and optionally the compensation mirror element should the latter not be a constituent part of the deflection device.

At least one scanning mirror element and at least one compensation mirror element can also be embodied in such a way that they are movable in two dimensions, preferably horizontally and vertically. As a result of a movement of the scanning mirror element and of the compensation mirror element in the same sense, both in the horizontal direction and in the vertical direction, a generated image of the spatial light modulation device as a segment is directed at a defined horizontal and vertical position in the field of view. By way of a movement in the same sense in one direction, for example horizontally, but an opposite movement in the direction perpendicular thereto, for example vertically, the position of the image of the spatial light modulation device as segment is displaced in one direction, for example vertically, but kept constant in a direction perpendicular thereto, for example horizontally.

The scanning mirror element can be moved continuously back and forth between a minimum setting and a maximum setting, for example a continuous movement from left to right and subsequently a continuous movement back from right to left during a slow movement from top to bottom. The scanning mirror element can be moved back to its initial position after the end of a frame.

However, a two-dimensional continuous movement of the at least one scanning mirror element can also be implemented for example in the form of Lissajous figures, and so the initial state of the scanning mirror element is re-attained after one frame.

There can be a one-time calibration, which is used to ascertain what settings of the scanning mirror element and optionally of the compensation mirror element correspond to which position of the image of the spatial light modulation device as a segment in the field of view. By way of example, if the scanning mirror element is provided with a stepper motor in the case of a stepwise movement thereof and controlled, there can be an assignment of a certain number of steps of the stepper motor to a position in the field of view.

In the case of a continuous movement of the scanning mirror element there can be an assignment via the speed of the movement and a time interval to a position in the field of view by means of a calibration.

By way of example, the calibration data can be stored in a lookup table and this lookup table can be used by the control device for controlling the scanning mirror element.

Preferably, the at least one combiner can be embodied as a light guide, where the spatial light modulation device is illuminated by the illumination device and the light modulated by the spatial light modulation device is directed at the deflection device which deflects the light on the combiner that is embodied as a light guide, where the light is coupled into the combiner and propagates in the latter, where the light propagating in the combiner is coupled out in accordance with the required defined position in the field of view and the at least one image of the spatial light modulation device as a segment is directed at this defined position.

In a particularly advantageous configuration of the invention, provision can be made for the at least one image of the spatial light modulation device as a segment to be displaced by means of a variable focus system in the z-direction along an optical axis of the optical system to a depth position in the field of view, at which a user accommodates.

Displacing the image of the spatial light modulation device as a segment to a depth position focused on by a user of the apparatus according to the invention or a depth position at which the user gazes can be implemented with a great accuracy by means of the variable focus system, in particular for those segments provided in the viewing direction or near the viewing direction of the user. Those segments that are represented and displayed further away from the viewing direction of the user in the field of view can be arranged either at any fixedly defined depth or at the same depth as the segments situated in the viewing direction of the user.

However, these segments are provided at the fixedly defined depth or at the same depth as the segments in the viewing direction of the user with a lower accuracy, i.e., with some tolerances. This may be relevant when using the same setting parameters of the variable focus system for all generated images of the spatial light modulation device as segments. In this case, the depth position of the image of the spatial light modulation device can vary on account of aberrations of the optical system, such as, e.g., field curvature, when imaging the spatial light modulation device for different images of the spatial light modulation device as segments.

By setting the correct depth position for the images of the spatial light modulation device as segments in accordance with the respectively ascertained depth of gaze of a user by means of a gaze tracking device in the viewing direction and by allowing some tolerances in the depth position of images of the spatial light modulation device as segments further away from the viewing direction of the user, a variable focus system with a low frame rate in comparison with the frame rate required for the deflection device can advantageously be used.

In one configuration of the invention, the apparatus according to the invention can be embodied as a stereoscopic display apparatus or as a varifocal stereoscopic display apparatus, in which an amplitude-modulating spatial light modulation device, to which two-dimensional amplitude data are written, is used.

In another embodiment of a stereoscopic display apparatus or varifocal stereoscopic display apparatus, the spatial light modulation device can be embodied as a complex-valued spatial light modulation device. By way of example, this can be a phase-modulating spatial light modulation device in combination with a beam combiner. In this case, the two-dimensional information to be represented is likewise written to the spatial light modulation device by means of amplitude data. The capability of the spatial light modulation device to modulate the phase of the light can then be used to write, e.g., phase functions for an aberration correction.

At least one grating element with a relatively low frequency, e.g., 50 Hz-200 Hz, and with a controllable tunable grating period can be used in combination with a spatial light modulation device which is operated at a relatively high frequency and may be embodied as a MEMS-SLM, and in combination with static optical elements for an aberration correction. In this way, the static optical elements can carry out an aberration correction for the entire display apparatus. The at least one grating element with a controllable tunable grating period can have the same lens function for all images of the spatial light modulation device as segments for the purposes of displacing the depth position of all segments, but can also provide for an aberration correction for this defined depth position of the segments. In this case, the aberration correction is the same for all segments. The fast MEMS-SLM can also carry out an individual aberration correction for the individual images of the spatial light modulation device as segments since both the two-dimensional image information and the phase function are updated in each segment for an aberration correction.

A scattering device or a diffuser can be provided in a stereoscopic display apparatus. By way of example, the scattering device can be arranged in the vicinity of the spatial light modulation device or in an intermediate image plane of the spatial light modulation device. The region of the sweet spot can be expanded using the scattering device such that a large virtual visibility region can be created in the observer plane.

In a further configuration of the invention, provision can be made for the virtual information to be generated and represented in holographic fashion in the field of view of a user. To this end, the spatial light modulation device can be embodied as an amplitude-modulating, a phase-modulating or a complex-valued (amplitude and phase) spatial light modulation device, to which holographic data are written or a hologram is encoded. Preferably, the spatial light modulation device has a complex-valued embodiment, e.g., as a phase-modulating spatial light modulation device in combination with a beam combiner. In another configuration, it can be embodied as a phase-modulating spatial light modulation device, to which calculated holograms are written iteratively, for example using a Gerchberg-Saxton method.

A holographic display apparatus usually does not require a variable focus system since the three-dimensional information to be represented can already be generated with the complete depth information by means of the hologram encoded in the spatial light modulation device.

However, it may be expedient under certain circumstances to provide a gaze tracking device and/or a variable focus system in a holographic display apparatus in order to displace the depth position of the image of the spatial light modulation device or place the latter at a defined position. By way of example, the complexity of the hologram calculation can be reduced by way of a suitable choice of the depth position of the image of the spatial light modulation device.

In a configuration of a holographic display apparatus, provision can also be made of at least one grating element with a controllable tunable grating period which does not change the position of the image of the spatial light modulation device as a segment but which is provided for aberration correction.

In a manner similar to a varifocal system, a holographic display apparatus once again allows a correction of aberrations to be combined with a static optical element or else to carry out an aberration correction by means of at least one grating element with a controllable tunable grating period, where the grating period may be different for each frame and depends on the information to be represented in the respective frame. Additionally, an aberration correction could be undertaken directly in the spatial light modulation device such that the correction of aberrations is already taken into account and included when calculating a hologram. The hologram encoded in the spatial light modulation device can be different for each image, to be generated, of the spatial light modulation device as segment carrying the virtual information.

If a grating element with a controllable tunable grating period can be operated at a sufficiently high frequency, a different aberration correction could also be carried out by the grating element for each image of the spatial light modulation device as a segment.

If the light emanating from the spatial light modulation device is incident on the at least one combiner at a relatively large oblique angle, then a static aberration correction could also be carried out, within the scope of which the spatial light modulation device is tilted relative to the optical system of the display apparatus according to the invention during the imaging of the spatial light modulation device.

There now are various options to advantageously configure the teaching of the present invention and/or combine the described exemplary embodiments or configurations with one another. To this end, reference should be made firstly to the patent claims dependent on the independent patent claims and secondly to the following explanation of the preferred exemplary embodiments of the invention on the basis of the drawings, in which generally preferred configurations of the teaching are also explained. Here, the invention is explained in principle on the basis of the exemplary embodiment described without intended to be restricted thereto.

In the figures:

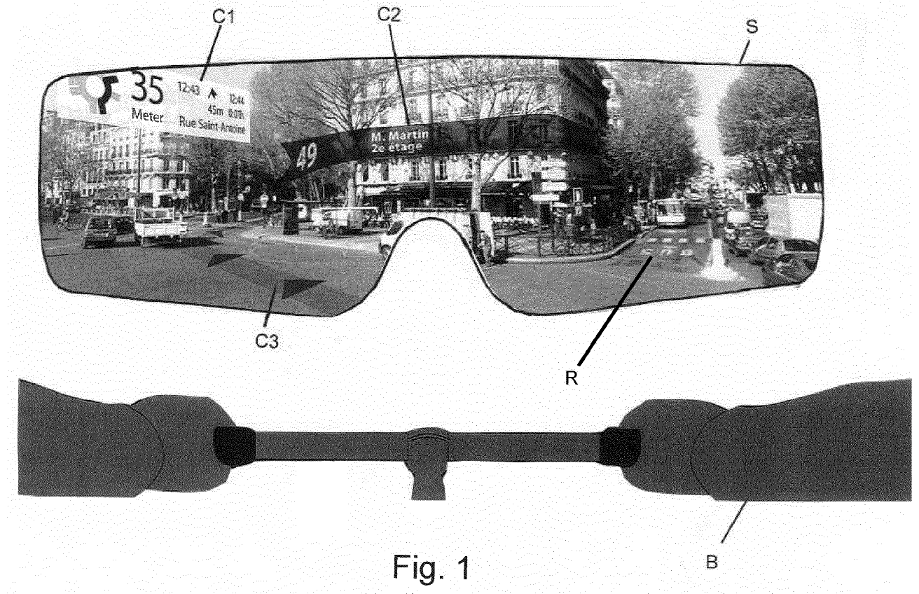

FIG. 1: shows an outline representation of an AR display apparatus, illustrated in the form of a pair of spectacles, in which only the field of view of a user is shown;

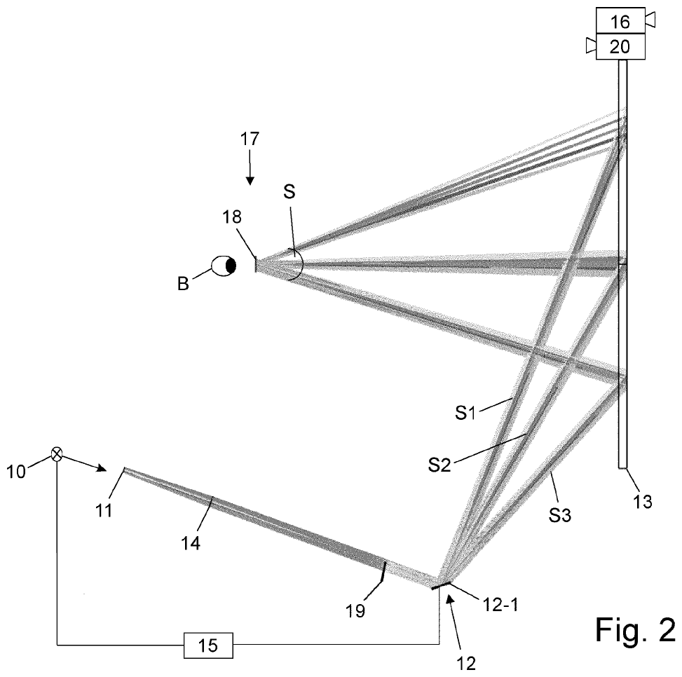

FIG. 2: shows an outline representation of a display apparatus according to the invention in a top view;

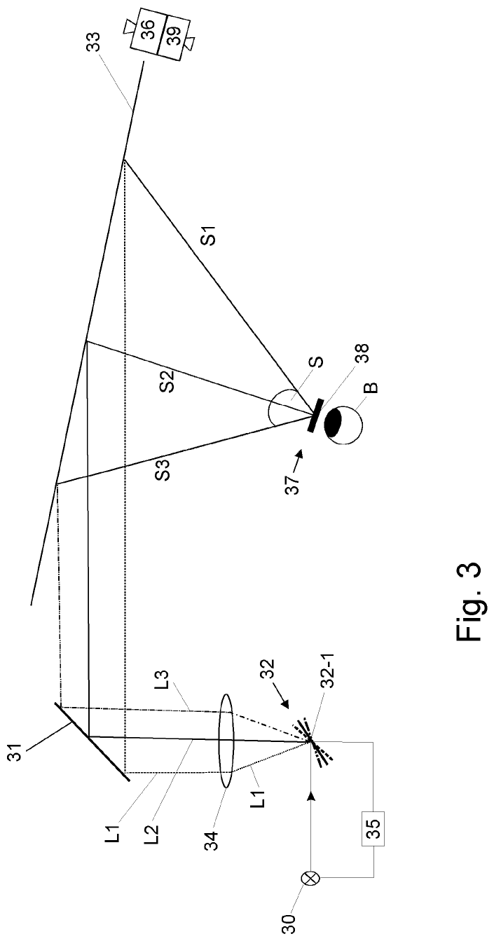

FIG. 3: shows an outline representation of a further embodiment of a display apparatus according to the invention in a top view;

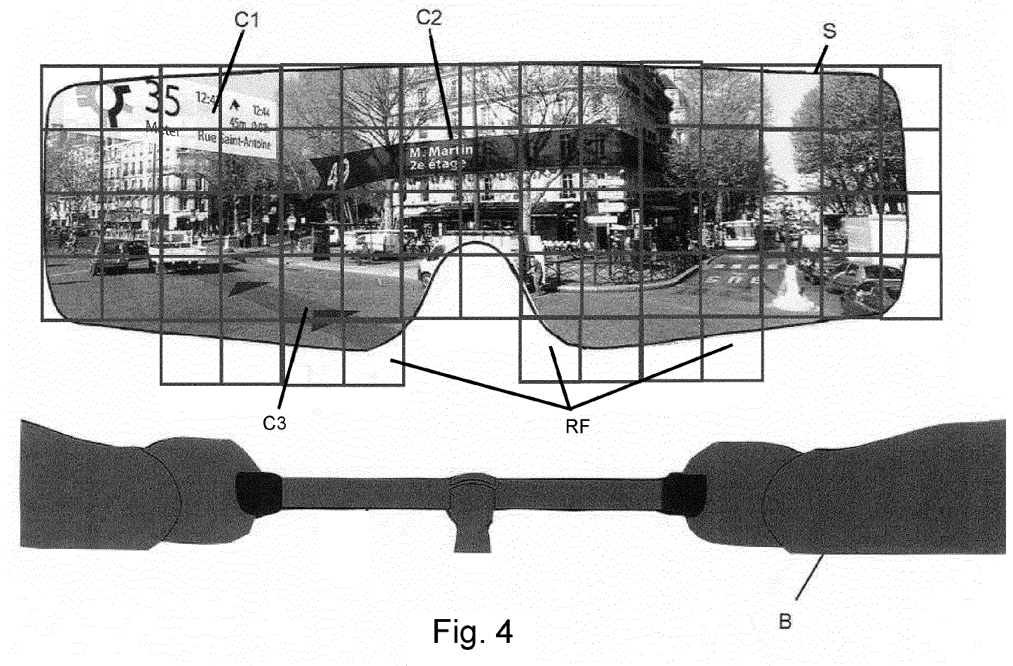

FIG. 4: shows an outline representation of a subdivision of the field of view of a user according to FIG. 1 into grid fields;

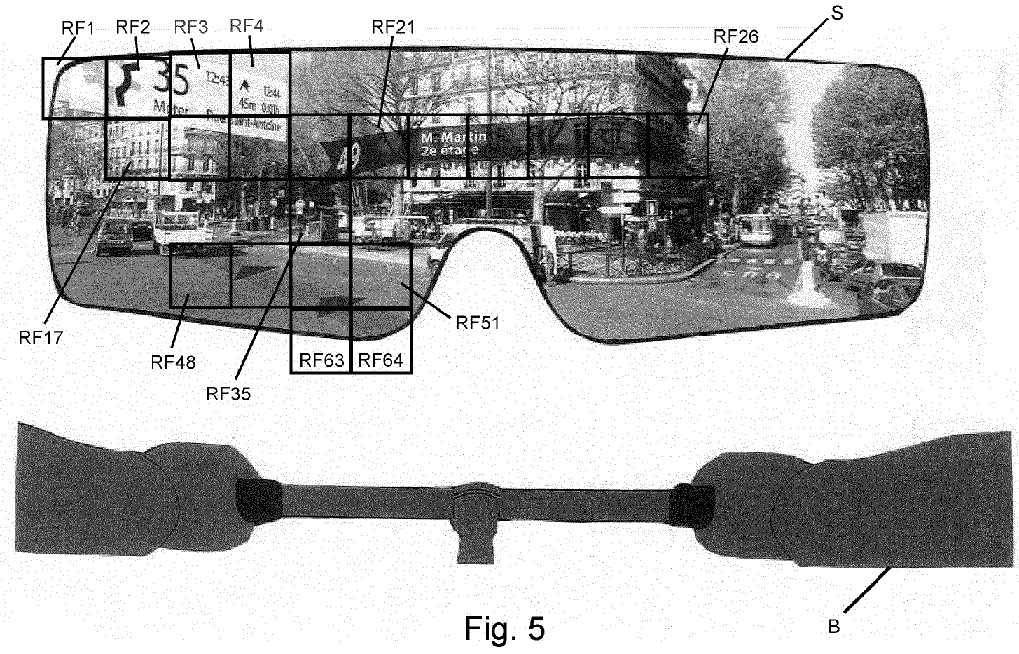

FIG. 5: shows an outline representation of images of a spatial light modulation device as segments in the field of view, which each contain virtual information for a user;

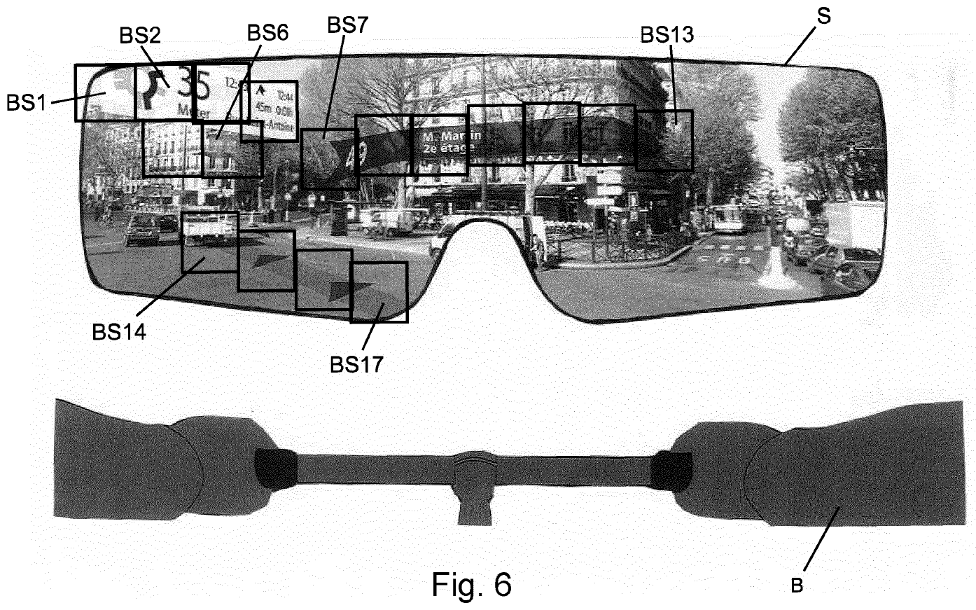

FIG. 6: shows a further outline representation of images of a spatial light modulation device as segments in the field of view, which each contain virtual information for a user;

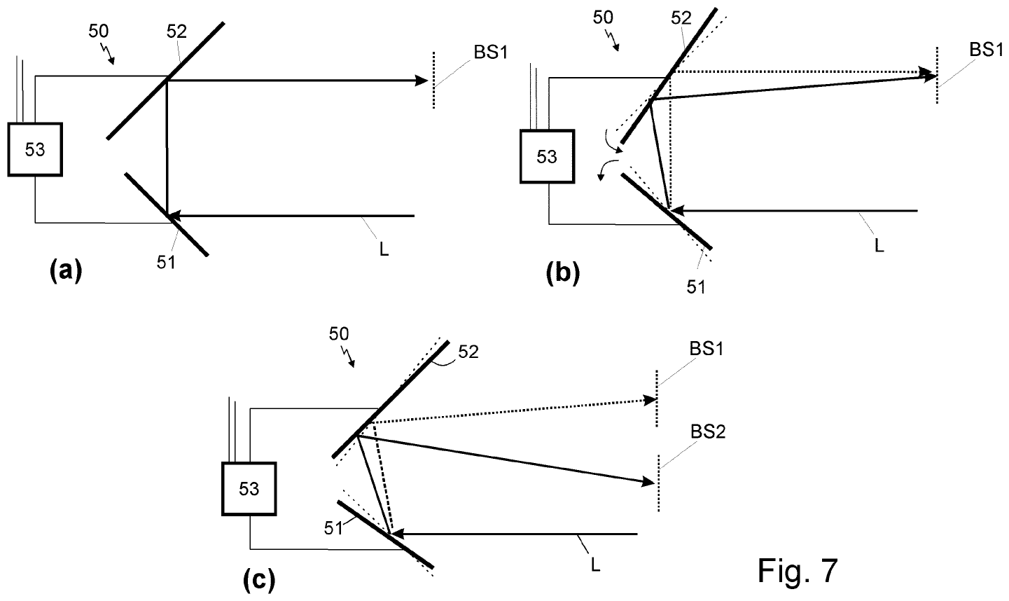

FIG. 7: shows an outline representation of a deflection device according to the invention in various control states, said deflection device being provided in a display apparatus according to the invention;

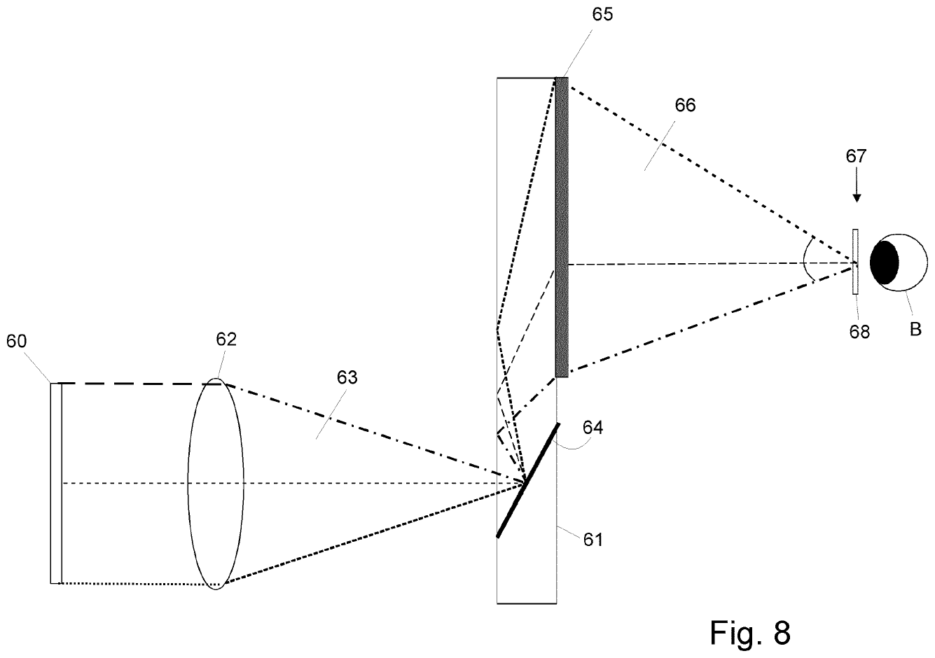

FIG. 8: shows an outline representation of coupling of light into a light guide when using a spatial light modulation device with a relatively large number of pixels, according to the prior art; and

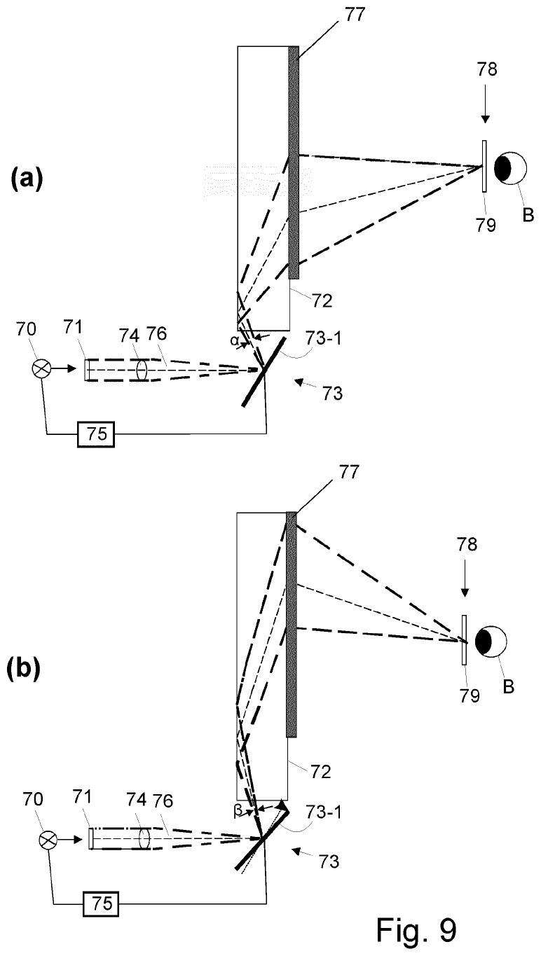

FIG. 9: shows an outline representation of a display apparatus according to the invention which comprises a combiner embodied as a light guide and which is provided to generate at least two images of a spatial light modulation device as segments in the field of view, when using a spatial light modulation device with a relatively small number of pixels.

It should be mentioned briefly that the same elements/component parts/components may also have the same reference signs in the figures.

FIG. 1 illustrates a display apparatus according to the invention, which is embodied here as an augmented reality (AR) display. In this case, the AR display apparatus is embodied in the form of a pair of spectacles such that the display apparatus is embodied as an AR head-mounted display, with the illustration showing what a user B of the AR glasses can observe through the latter in their field of view S. For reasons of clarity, the user B in this case is only represented by two arms with two hands which are holding a handlebar of a bicycle, for example. The display apparatus in the form of a pair of AR glasses is fastened to the head of the user B. Consequently, the user B gazes through the AR glasses and can observe their natural or physical surroundings R therethrough. FIG. 1 consequently only shows the field of view S of the user B. In their field of view, the user B sees a street scene with buildings, roads and traffic in FIG. 1, with the user seeing this street scene with both of their two eyes.

The illustrated shape of the spectacle lens should not relate here to any particular type of AR glasses but instead should only serve as an example of how the shape of a pair of AR glasses could be configured. It is therefore self-evident that other shapes of AR glasses are also possible. Moreover, this means that although the display apparatus illustrated in the figures in this case is embodied in the form of a pair of spectacles, other applications are also possible, for example as a head-up display.

Further, virtual information items C1, C2 and C3 are represented or displayed in the field of view S of the user B by means of the display apparatus, said virtual information being superimposed on the physical surroundings R and being able to be displayed to the user B in addition to their physical surroundings R. Illustrated in the field of view S as virtual information are a traffic sign C1, information about a shop C2 which is situated in a building and arrows C3 as navigation aids, which are intended to indicate a street direction. The represented virtual information items C1, C2 and C3 consequently only fill a small part of the field of view S. This means that only a small percentage of the field of view S is formed by virtual information. The majority of the field of view S of the user is formed by the content of the physical surroundings R.

FIG. 2 illustrates a possible configuration of the display apparatus. This configuration could find use both for an AR head-mounted display and for a head-up display. In the following, the display apparatus should be embodied as an AR head-mounted display in order to establish a link to FIG. 1.

The display apparatus comprises an illumination device 10 which may have at least one light source, where three light sources according to the primary colors RGB (red-green-blue) may be provided for a color representation of the virtual information. A spatial light modulation device 11, which is denoted SLM below, follows the illumination device 10 in the light direction such that the illumination device illuminates the SLM. The SLM 11 is embodied as an SLM with a relatively small number of pixels, for example with less than 1000 pixels in one direction.

Following the SLM 11 in the light direction there now is a deflection device 12 and a combiner 13, both of which are components of an optical system of the display apparatus. In this case, the deflection device 12 comprises a scanning mirror element 12-1, which is arranged in movable fashion and which can move or rotate about its axis of rotation. The deflection device 12 with the scanning mirror element 12-1 is arranged in the beam path between the SLM 11 and the combiner. The scanning mirror element 12-1 can carry out a continuous movement or else a stepwise movement with a fixedly defined increment, by means of which incident light can be deflected in a certain direction. The combiner 13, which then is embodied as a spectacle lens as per FIG. 1, is provided to superimpose virtual information generated by the display apparatus on information from the physical surroundings in the field of view of the user. The combiner 13 is embodied in such a way that light from the physical surroundings can pass through the combiner unimpeded, i.e., is not influenced by the combiner. The combiner 13 can have a flat or plane, or else curved embodiment. As illustrated in FIG. 2, the optical system can comprise further imaging elements, for example an imaging element 14 which is embodied as a passive lens element in this case.

Moreover, the display apparatus comprises a control device 15, which is coupled to the illumination device 10 and the deflection device 12. As a result, the illumination device 10 can be controlled on the basis of a control of the deflection device 12, in this case the scanning mirror element 12-1 in particular, and can be switched accordingly, i.e., brought into an ON state and an OFF state. The control device 15 could also be coupled to the SLM 11. However, it is also possible for the SLM 11 to be operated by its own control device for writing data.

The general procedure when generating virtual information, for example the virtual information C1 as per FIG. 1, is described below. The virtual information should be generated in a holographic way, with a stereoscopic generation naturally also being possible.

If the illumination device 10, which is controlled by the control device 15, has been put into a corresponding ON state, the illumination device 10 emits light which is substantially sufficiently coherent and which is incident on the SLM 11, where virtual information data are transferred or transmitted to the SLM 11. The light emitted by the illumination device 10 and incident on the SLM 11 is represented here by an arrow. The light modulated by the SLM 11 with the virtual information to be represented passes through the imaging element 14, as a result of which an image of the SLM 11 is generated on the scanning mirror element 12-1 of the deflection device 12. The deflection device 12 is arranged in a Fourier plane of the SLM 11. Already before the illumination device 10 was controlled, the scanning mirror element 12-1 was controlled by the control device 15 such that it has moved to a position which is required for representing this virtual information at a defined position in the field of view S of a user B, who is to be represented here by the eye. To determine the position to which the scanning mirror element 12-1 has to move so that virtual information in the field of view S is also represented at the correct position, a detection device 16 is used before the generation of the virtual information to determine, for each frame, which region of the field of view S should be filled with virtual information, for example a two-dimensional or three-dimensional object or scene, and which region in the field of view S should contain no virtual information but only information from the physical surroundings of the user B. The image of the SLM 11 is now, as segment S1, directed in the direction of the combiner 13 by means of the scanning mirror element 12-1, said combiner 13 superimposing the image of the SLM 11 as segment S1 on the physical surroundings. Moreover, the image of the SLM 11 as segment S1 is imaged by the combiner 13 in an observer plane 17 in order to generate a virtual visibility region 18 there. The virtual visibility region 18 can be a virtual observer window in the case of a holographic display apparatus or a sweet spot in the case of a stereoscopic display apparatus. In this way, the virtual information is represented and displayed at the defined position in the field of view S.

To be able to observe the virtual information in the field of view S, the user B must arrange their eye in the observer plane 17 and gaze through the virtual visibility region 18.

To represent further virtual information in the field of view S of the user B, the same described procedure can be carried out. Consequently, images of the SLM 11 can be generated as segments S2 and S3, for example, and can be directed at the demanded and defined positions in the field of view S by means of the scanning mirror element 12-1, and these segments S2 and S3 can be superimposed on the physical surroundings by means of the combiner 13 and can be represented and displayed for the user B in the field of view S. The images of the SLM 11 as segments S1, S2 and S3 are generated time-sequentially and are represented and displayed in the field of view S. However, this is implemented at such a high frequency that the eye of the user B cannot recognize this successive generation of the segments S1, S2 and S3 with the naked eye and therefore perceives this generation to be simultaneous.

The same procedure is carried out in subsequent frames: where virtual information should be displayed in the field of view S is detected first and this virtual information is then generated as segments time-sequentially and represented in the field of view as a superimposition on the physical surroundings of the user B.

In this way, a large field of view can be created even by generating only a few segments containing the demanded virtual information.

The combiner 13 can also comprise a fixed (non-variable) focusing element, for example a grating element.

The display apparatus in FIG. 2 further comprises a variable focus system 19. The variable focus system 19 allows the distance between the image of the SLM 11 as a segment in the field of view and the user B to be varied, i.e., the depth of the image of the SLM 11 as a segment in the field of view S to be set. The variable focus system 19 is preferably arranged in the region of the Fourier plane of the SLM 11, i.e., in the Fourier plane of the SLM 11 or at least in the vicinity of the Fourier plane of the SLM 11, and can comprise for example at least one grating element with an adjustable tunable grating period, into which a lens function is written. Preferably, the depth of the image of the SLM 11 as a segment can be set in conjunction with the detection of a direction of view of the user B. A gaze tracking unit 20 determines the direction of view of the user B and also the depth position in the field of view, at which the user B is focused, or the depth focused on. The generated image of the SLM 11 as a segment can then be displaced by means of the variable focus system 19 to that depth position in relation to the user B which the user B at that moment focuses on or gazes at.

The variable focus system is not absolutely necessary in a holographic display apparatus since the virtual information is already representable at its demanded depth by way of holography.

However, the use of a variable focus system could nevertheless be useful, for example in order to correct aberrations caused by the optical system as a result of displacing the image of the SLM 11 as a segment in the depth or along the z-direction. The variable focus system 19 can comprise at least one grating element with an adjustable tunable grating period, which has prism functions or phase functions, for example.

In a stereoscopic display apparatus, it is expedient to use such a variable focus system 19 in order to displace the image of the SLM as a segment in terms of its depth and/or in order to correct aberrations of the optical system.

FIG. 3 represents a further display apparatus, which likewise can be embodied as an AR display apparatus or AR display and which can find use both as an AR head-mounted display and as an AR head-up display.

The display apparatus comprises an illumination device 30, an SLM 31, a deflection device 32, a combiner 33 and imaging elements, of which only an imaging element 34 is shown here. The deflection device 32, the combiner 33 and the imaging element 34 are components of an optical system of the display apparatus. In this configuration of the display apparatus the deflection device 32, which also comprises a scanning mirror element 32-1 in this case, already follows the illumination device 30. The imaging element 34, the SLM 31 and the combiner 33 are arranged downstream of the deflection device 32 in the light direction. Consequently, this means that the deflection device is provided between the illumination device 30 and the SLM 31 in this case. In this case, the SLM 31 is embodied as an SLM with a relatively large number of pixels, for example with more than 1000 pixels in one direction. The scanning mirror element 32-1 of the deflection device 32 has a movable arrangement, as should be rendered identifiable by the dashed lines, and can consequently move or rotate about its axis of rotation. In this case, too, the scanning mirror element 32-1 can carry out a continuous movement or else a stepwise movement with a fixedly defined increment, by means of which incident light can be deflected in a certain direction. The combiner 33, which can also be embodied as spectacle lens in this exemplary embodiment but should not be construed as being restricted thereto, is provided for superimposing virtual information generated by the display apparatus on information in the physical surroundings in the field of view S of the user B. The combiner 33 is also embodied here in such a way that light from the physical surroundings can pass through the combiner 33 unimpeded, i.e., is not influenced by the combiner 33. The combiner 33 can have a flat or plane, or else curved embodiment.

Additionally, the display apparatus comprises a control device 35, which is coupled to the illumination device 30 and the deflection device 32. As a result, this exemplary embodiment also provides for the illumination device 30 to be able to be controlled on the basis of a control of the deflection device 32, in this case the scanning mirror element 32-1 in particular, and to be able to be switched accordingly, i.e., brought into an ON state and an OFF state. The control device 35 could also be coupled to the SLM 31. However, it is also possible for the SLM 31 to be operated by its own control device for writing data. Moreover, the display apparatus can also comprise a gaze tracking device 39 which determines the direction of view of the user B and also the depth position in the field of view, at which the user B is focused, or the depth focused on. If necessary, the generated image of the SLM 31 as a segment can then be displaced by means of a variable focus system to that depth position in relation to the user B which the user B at that moment focuses on or gazes at.

The general procedure when generating virtual information, for example the virtual information C1 as per FIG. 1, is described below in conjunction with the display apparatus illustrated in FIG. 3. In this case, too, the virtual information should be generated in a holographic way, with a stereoscopic generation naturally also being possible.

If the illumination device 30, which is controlled by the control device 35, has been put into a corresponding ON state, the illumination device 30 emits light which is substantially sufficiently coherent and which is incident on the deflection device 32, in particular the scanning mirror element 32-1. Now, the deflection device 32 is arranged upstream of the SLM 31 in the light direction in this case. Already before the illumination device 30 was controlled, the scanning mirror element 32-1 was controlled by the control device 35 such that it has moved to a position which is required for representing the demanded virtual information at a defined position in the field of view S of a user B, who is to be represented here by the eye. To also determine the position to which the scanning mirror element 32-1 has to move so that virtual information in the field of view S is also represented at the correct position in this configuration of the display apparatus, a detection device 36 is used before the generation of the virtual information to determine, for each frame, which region of the field of view S should be filled with virtual information, for example a two-dimensional or three-dimensional object or scene, and which region in the field of view S should contain no virtual information but only information from the physical surroundings of the user B. The light emitted by the illumination device 30 and incident on the scanning mirror element 32-1 is likewise represented here by an arrow. The light L1 which has been reflected and directed by the scanning mirror element 32-1 of the deflection device 32 in accordance with a defined position in the field of view S is then incident on the imaging element 34 which collimates the light L1. This collimated light L1 now is incident on the SLM 31, with only a portion of the SLM 31 being illuminated in the process. According to FIG. 3, only a left portion of the SLM 31 is illuminated by means of the light L1, where this portion can be the entire left region of the SLM 31 or else only a portion in the left region of the SLM 31. The illustration should be viewed as purely exemplary. Moreover, the virtual information data are transferred or transmitted to the corresponding portion of the SLM 31, the left portion in this case. Consequently, the information for the virtual information in the field of view S to be represented by the light L1 is only situated on the SLM 31 in this illuminated portion. The light incident on this portion of the SLM 31 is modulated with the information to be represented and then is incident on the combiner 33 as segment S1. The combiner 33 now serves as an imaging element for generating an image of the SLM 31, in this case an image of the portion of the SLM 31, and also superimposes this image of the SLM 31 as segment S1 on the physical surroundings of the user B. The image of the SLM 31 as segment S1 is imaged into an observer plane 37, as a result of which a virtual visibility region 38 is formed. The virtual visibility region 38 can be a virtual observer window in the case of a holographic display apparatus or a sweet spot in the case of a stereoscopic display apparatus. In this way, the virtual information is represented and displayed at the defined position in the field of view S.

To be able to observe the virtual information in the field of view S, the user B must arrange their eye in the observer plane 37 and gaze through the virtual visibility region 38.

To represent further virtual information in the field of view S of the user B, the same described procedure can be carried out. Consequently, different directions of light beams L2, L3 which correspond to demanded positions of the virtual information in the field of view S can be created by different positions of the scanning mirror element 32-1 of the deflection device 32, for example, said light beams then being incident on different portions of the SLM 31.

Consequently, images of the SLM 31 as segments S2 and S3 are generated, directed at the demanded and defined positions in the field of view S, and represented and displayed for the user B in the field of view S. The images of the SLM 11 as segments S1, S2 and S3 are generated time-sequentially and are represented and displayed in the field of view S. However, this is implemented at such a high frequency that the eye of the user B cannot recognize this successive generation of the segments S1, S2 and S3 with the naked eye and therefore perceives this generation to be simultaneous.

The same procedure is carried out in subsequent frames: where virtual information should be displayed in the field of view S is detected first and this virtual information is then generated as segments time-sequentially and represented in the field of view as a superimposition on the physical surroundings of the user B.

In this way, a large field of view can be created even by generating only a few segments containing the demanded virtual information.

The combiner 33 can also comprise a fixed focusing element, for example a grating element.

The display apparatus as per FIG. 3 can also comprise a variable focus system. In this case, the variable focus system can be embodied in accordance with the variable focus system 19 according to FIG. 2, and so the same should apply to the display apparatus as per FIG. 3.

The display apparatuses as per FIGS. 2 and 3 can be used for the following embodiments and configurations as per FIGS. 4 to 7 and 9, in which specific procedures of a method for generating virtual information are described.

FIG. 4 illustrates the AR glasses as per FIG. 1, which a user B wears on the head in order thereby to additionally obtain virtual information, which can be shown and displayed in the user's physical surroundings in the field of view.

As is evident, the field of view S of the user B is subdivided into individual grid fields RF, which are arranged as a type of grid or which form a grid arrangement. In this case, the grid fields RF all have the same shape and the same size. They have a square embodiment in this exemplary embodiment. Naturally, the grid fields RF may also have a different shape and size. Moreover, the size and shape of the grid fields can vary over the field of view S.

To now generate the virtual information items C1, C2 and C3 using the display apparatus, superimpose said virtual information items on the physical surroundings of the field of view and display said information items to the user B, the field of view S with the grid fields RF is scanned and the detection device is used to determine where in the field of view the virtual information items C1, C2 and C3 that are useful for the user B should be represented or displayed. That is to say, the grid fields RF of the field of view S in which the virtual information items C1, C2 and C3 should be represented are checked and determined. This is because it is only these grid fields RF of the field of view S that need to be filled with appropriate virtual information, which is superimposed on the real information present there. The scanning of the field of view can be implemented grid field by grid field in line-by-line or column-by-column fashion.

The generation and representation of virtual information, for example the virtual information C1 as per FIG. 1, is now implemented as set forth below. To explain the procedure, a line scan of the field of view is assumed, where the procedure can naturally also be carried out column-by-column. For each frame, each grid field RF of the field of view S is successively homed in on line-by-line by means of a stepwise movement, with a defined increment, of the scanning mirror element of the deflection device and an image of the SLM as a segment is only assigned to the grid field in which virtual information should also be represented. In respect of the representation of the virtual information C1, this now means that the grid field RF1 in the field of view is homed in on by means of the scanning mirror element, wherein the fact that virtual information should be represented in this grid field RF1 is known as a result of the previously carried out scan of the entire field of view and the determination of the grid fields in which virtual information should be represented. On account of this determination, the moving scanning mirror element is put into a stop state by means of the control device such that, likewise by means of the control device, the illumination device is controlled and brought into an ON state, whereupon an image of the SLM as a segment is generated and assigned to the grid field RF1 in conjunction with the SLM and the combiner and the at least one imaging element of the optical system. As a result, part of the virtual information C1 is displayed. The control device controls the scanning mirror element and the illumination device anew such that the scanning mirror element is put into an ON state and the illumination device is put into an OFF state. The scanning mirror element now moves on by a defined increment such that a grid field RF2 is homed in on, it likewise having been determined in the respective thereof that this grid field RF2 contributes to the representation of the virtual information C1. The control device now controls the scanning mirror element and the illumination device again accordingly so the scanning mirror element is put into the stop state and the illumination device is put into the ON state. Thereupon, an image of the SLM as a segment, which corresponds to the part of the virtual information to be represented, is generated by means of the SLM, the combiner and the at least one imaging element of the optical system and is assigned to the grid field RF2 such that the corresponding virtual information is displayed there. The two subsequent grid fields RF3 and RF4 are homed in on by the scanning mirror element in accordance with what was disclosed above and an image of the SLM as a segment, which carries the virtual information, is generated in each case. These two images of the SLM as segments are then assigned to the two grid fields RF3 and RF4, as is evident in FIG. 5. Then, the scanning mirror element is moved on stepwisely with a defined increment along this upper line of the grid and in each case moved into a stop state and an ON state when scanning the further grid fields. Since the further grid fields RF5 to RF15 of this line were determined to require no provision or display of virtual information, the control device will not control the illumination device and so the illumination device remains in an OFF state and no images of the SLM as segments are generated for these grid fields RF5 to RF15. Thereupon, the second line of the grid is homed in on by means of the scanning mirror element, where, as per FIG. 5, no image of the SLM as a segment is generated for the first grid field RF16 since no virtual information should be displayed in this grid field. For the following grid fields RF17 to RF26, the grid field is respectively homed in on by means of the scanning mirror element as described above and an appropriate image of the SLM as a segment is generated and this segment is assigned to the corresponding grid field such that a virtual information item can be displayed in the grid fields. In the same way, each grid field of the grid is successively homed in on by means of the scanning mirror element and an image of the SLM as a segment is generated for each of the further grid fields RF35 and RF48 to RF51 and RF63, RF64, and assigned to and displayed in the associated grid field. Consequently, the grid fields RF1, RF2, RF3, RF4, RF17, RF18 and RF19 contribute to represent the virtual information C1. The grid fields RF20 to RF26 and RF35 contribute to the representation of the virtual information C2 and the grid fields RF48 to RF51 and RF63, RF64 contribute to the representation of the virtual information C3. In this case, the above-described procedure is carried out for each frame. The generation and representation of the individual images of the SLM as segments is implemented time-sequentially.

The method was described for a stepwise movement of the scanning mirror element. However, it is also possible for the scanning mirror element to carry out a continuous movement. FIG. 7 describes this later in detail.

Further, the procedure can also be modified slightly. In this case, too, the field of view is initially subdivided into grid fields RF in the style of a grid, said grid fields then being scanned and the detection device being used to determine where in the field of view the virtual information items C1, C2 and C3, which are useful for the user B, should be represented or displayed. That is to say, the grid fields RF of the field of view S in which the virtual information items C1, C2 and C3 should be represented are checked and determined. This is because it is only these grid fields RF of the field of view S that need to be filled with appropriate virtual information, which is superimposed on the real information present there. In this procedure, too, the scanning of the field of view can be implemented grid field by grid field in line-by-line or column-by-column fashion. However, unlike in the preceding exemplary embodiment as per FIG. 5, all grid fields RF of the grid are not homed in on successively by means of the scanning mirror element in line-by-line or column-by-column fashion; instead, it is only those grid fields RF in which the virtual information items C1, C2 and C3 should be represented and displayed or which should contribute to the representation of the virtual information C1, C2, C3. This is because it is only for these grid fields RF that the control device must control the scanning mirror element and the illumination device accordingly in each case so that an image of the SLM as a segment can be generated and represented. This procedure could be more efficient in the generation and representation of the virtual information.

FIG. 6 shows a further exemplary embodiment in relation to the procedure when generating and representing virtual information items. In this case, the positioning of the images of the SLM as segments for representing the virtual information items is not implemented on a grid or a fixed grid, as explained in the exemplary embodiments as per FIGS. 4 and 5, but this is freely selectable in the field of view of the user B of the display apparatus. In this way, it is possible to reduce the number of images of the SLM as segments for representing the same virtual information C1, C2 and C3 or the same content as in FIGS. 4 and 5. This means that the virtual information items C1, C2 and C3 can be generated in FIG. 6 with a smaller number of images of the SLM as segments, specifically using only 17 images of the SLM as segments instead of 21 images of the SLM as segments as per FIG. 5. Consequently, for each frame, the images of the SLM as segments for the respective virtual information C1, C2 or C3 are only generated at those positions in the field of view at which the information is also required.

To this end, the images of the SLM as segments are generated in such a way that the virtual information as an object assumes the entire image of the SLM where possible if the object is larger than the image of the SLM in terms of its extent, or the virtual information as an object is provided fully in the image of the SLM if the object is smaller than the image of the SLM in terms of its extent. By way of example, the center of the object can coincide with the center of the image of the SLM as a segment. What this can achieve is that the demanded virtual information can be represented using only a minimum number of images of the SLM as segments.

By way of example, the virtual information C1 is generated and represented in the field of view as set forth below. The detection device is used to determine the position in the field of view at which the virtual information C1 should be represented and displayed. Thereupon, the number of images of the SLM as segments with which the information C1 to be represented with as few images as possible, or with even only one image of the SLM as a segment, must be generated and can be represented is determined. If a suitable number and also the demand position of the respective image of the SLM as segment have been determined in the field of view S, the scanning mirror element of the deflection device is moved by means of the control device to the relevant position for an image of the SLM as a segment in the field of view S and is then held in a stop state. Data of the virtual information to be represented in this segment are transmitted to the SLM or generated by the SLM itself and encoded on the latter, preferably already during the movement of the scanning mirror element and/or while the stop state of the scanning mirror element is maintained. After the completion of the transfer or generation of the data for this segment to or by the SLM and while the stop state of the scanning mirror element is maintained, the control device then controls the illumination device such that the latter is switched into the ON state, whereupon data of the virtual information to be represented are represented in this segment in such a way that the virtual information, as overall information or as partial information, is placed completely into the image of the SLM such that only a few images of the SLM as segments are required to represent the virtual information in the field of view S. The illumination device now illuminates the SLM in order to modulate the light in accordance with the virtual information and in order to generate an image of the SLM as a segment BS1 in conjunction with the combiner and the optical system, and direct said image at the determined position in the field of view S by means of the scanning mirror element. Then, to represent the virtual information C1, a further image of the SLM as a segment BS2 is generated and represented in the same way. This procedure is implemented until the virtual information C1 is completely displayed in the field of view S for the user. The generation and representation of the images of the SLM as segments is consequently also implemented time-sequentially in this exemplary embodiment. As is evident from FIG. 6, the individual images of the SLM as segments may also overlap in order to represent the virtual information C1 as per FIG. 1. The generation and representation of the virtual information items C2 and C3 is implemented in the same way as the generation and representation of the virtual information C1.

So that a further virtual information item, for example the virtual information C2 or C3 of FIG. 1, is facilitated straight after the generation and representation of the virtual information C1 in the same frame so that the eye of the user does not perceive the time-sequential representation of the virtual information items as a successive generation but substantially at the same time, the scanning mirror element can be moved at a higher speed from the position of the image of the SLM as a segment BS6 to, for example, a position for the yet to be generated image of the SLM as a segment BS7 for the virtual information C2 in order to traverse the gap present between these two segments BS6 and BS7 quicker. Here, the speed of the movement of the scanning mirror element should be higher than when homing in on the respective position for the image of the SLM as a segment for the virtual information C1. Then, homing in on the respective positions of the images of the SLM as segments, yet to be generated and represented, for the virtual information C2 in the field of view S can be implemented at a lower speed of the movement of the scanning mirror element, similar to the speed when representing the virtual information C1. The generation and representation of the respective images of the SLM as segments for the virtual information C2 is implemented in the same way as for the generation and representation of the virtual information C1. The same procedure can likewise be used for representing the virtual information C3. Here too, the transition from the last generated image of the SLM as a segment BS 13 for the virtual information C2 to the yet to be generated image of the SLM as segment BS 14 of the virtual information C3 can be implemented at a greater speed of the movement of the scanning mirror element in order to traverse the large gap quicker in time. This sequence of homing in on positions and generating images of the SLM as segments in the field of view S should merely be exemplary. Naturally, a different sequence is also possible. By way of example, following the last image of the SLM as a segment BS13, the image of the SLM as a segment BS17 yet to be generated could also be generated and represented since the gap between the two segments BS13 and BS17 is not as large as between the segments BS13 and BS14, and consequently this position of the segment BS17 can be homed in on quicker.

As is evident in FIG. 6, the images of the SLM as segments are represented freely in the field of view, can overlap one another and can also have different shapes and/or sizes.

FIGS. 4 to 6 were used to describe the generation and representation of virtual information with the aid of a stepwise movement of the scanning mirror element with a defined increment.

However, it is also possible for the stepwise movement of the scanning mirror element in these exemplary embodiments of FIGS. 4 to 6 to be replaced by a continuous movement of the scanning mirror element and represent an image of the SLM as a segment in the field of view in this way.

Such a deflection device which provides for a continuous movement of a scanning mirror element is illustrated in FIG. 7. Illustrations a), b) and c) in FIG. 7 represent the generation of two images of the SLM as segments. A deflection device 50 comprises a scanning mirror element 51 and a compensation mirror element 52. The scanning mirror element 51 is the element of the deflection device 50 which performs a continuous movement. The compensation mirror element 52 is likewise mounted in movable fashion. The scanning mirror element 51 and the compensation mirror element 52 are arranged at an angle to one another, as is evident from FIG. 7. This angle is approximately 90 degrees in the illustration (a) of FIG. 7. Both the scanning mirror element 51 and the compensation mirror element 52 are controlled by a control device 53, which likewise also controls an illumination device (not illustrated) and optionally also controls an SLM.

Illustration a) in FIG. 7 represents the generation of a first image of the SLM as segment BS1. To this end, the two mirror elements 51 and 52 form a defined angle with respect to one another at the instant of the generation of the image of the SLM as a segment BS1 at a predefined position in the field of view of the user, with the compensation mirror element 52 remaining stationary, i.e., not being in motion. By contrast, the scanning mirror element 51 continues to move continuously. The light L incident on the deflection device 50 consequently is initially incident on the scanning mirror element 51 and is reflected by the latter in accordance with its alignment in the direction of the compensation mirror element 52. The light incident on the compensation mirror element 52 is likewise reflected by the latter in accordance with its alignment, is incident on the combiner and is then directed at a corresponding position in the field of view of the user. By way of example, this embodiment of the deflection device 50 could occur when a first image of the SLM as a segment is generated at a defined position in the field of view such that at the instant of a first control of the scanning mirror element 51 by the control device 53 for a continuous movement the illumination device is also already controlled by means of the control device 53 and emits light in order to generate and represent an image of the SLM as a segment for virtual information in the field of view at precisely this first position of the scanning mirror element.

Illustration b) of FIG. 7 shows that the scanning mirror element 51 has moved or rotated under control of the control device 53 from the dashed position to another position, which is intended to be represented by the solid line, along the illustrated arrow. In the process, the compensation mirror element 52 is co-rotated in the same direction through the same absolute value as the scanning mirror element 51 so that at the time at which the illumination device is controlled by the control device 53 of the display apparatus and put into an ON state, the SLM is illuminated and the image of the SLM as a segment is generated and represented at the same position in the field of view as in illustration a). Consequently, the image of the SLM as a segment BS1 is displayed at the same position in the field of view. This means that, furthermore, an image of the SLM as a segment can be generated and displayed at the same position as in illustration a) in the case of a continuous movement of the scanning mirror element 51. Consequently, the compensation mirror element 52 compensates the movement of the scanning mirror element 51. The dashed lines and arrows should indicate the incident light beam on the two mirror elements 51 and 52 as per illustration a), where the solid lines and arrows are intended to elucidate the incident light beam offset thereto.

In illustration c) of FIG. 7, the scanning mirror element 51 has been moved on continuously by controlling it with the control device 53. However, the compensation mirror element 52 has been rotated or moved in the opposite direction by means of the control device 53 such that said compensation mirror element has now moved from the dashed position to the solid line position. An image of the SLM as a segment BS2 is generated and represented in this way at a different position in the field of view to the image of the SLM as a segment BS1. The advantage of such an arrangement of scanning mirror element and compensation mirror element in the deflection device lies in the fact that continuously scanning or moving mirror elements frequently are faster in terms of the movement speed thereof than mirror elements that move stepwisely from point to point and are then stopped. In the exemplary embodiment as per FIG. 7, the image of the SLM as a segment BS1 could be displayed for the whole time between the states of the mirror elements 51 and 52 shown in illustrations a) and b), even while the mirror elements 51 and/or 52 move on or rotate on. Between illustrations b) and c) in FIG. 7, when the compensation mirror element 52 is moved into its initial state, no image of the SLM as a segment is generated until the demanded new position of the compensation mirror element 52 has been reached. During the movement of the compensation mirror element 52 into its initial state, the illumination device is deactivated or in the OFF state. Only once the compensation mirror element 52 has reached its new demanded position is the illumination device put back into the ON state by means of the control device 53. Then both mirror elements 51 and 52 or else only one of the two mirror elements could move on and another or further image of the SLM as a segment could be generated and displayed in the field of view to the user.

A general generation of information in combination with coupling of light into a light guide according to the prior art is illustrated in FIG. 8. In this case, use is made of an SLM 60 which has a relatively large number of pixels and which consequently has an HD (high-definition) TV resolution or higher. A coupling angular spectrum 63 of the light modulated by and emanating from the SLM 60 is generated by means of an imaging element 62, for example a lens element, arranged in the beam path between the SLM 60 and a light guide 61, in such a way that the light beams emanating from the individual pixels of the SLM 60 are incident on the light guide 61, on average at different angles relative to the surface of the light guide 61. This coupling angular spectrum 63 is incident on the light guide 61 and is coupled into the light guide 61 by means of a mirror surface 64. The mirror surface 64 is fixedly arranged within the light guide 61 at a defined angle. The light beams that are incident on the mirror surface 64 are reflected by the latter and propagate in the light guide 61 by way of total-internal reflection. By means of an outcoupling device 65 which has corresponding outcoupling elements, for example outcoupling grating elements, the light can be coupled out of the light guide 61 in the direction of an eye of a user B, as a result of which an outcoupling angular spectrum 66 is definable. An image of the SLM 60 is imaged in an observer plane 67 in order to generate a virtual visibility region 68 there.

Further options for the propagation of light in a light guide and an outcoupling of light from the same are described, for example, in WO 2019/012028 A1, with the disclosure of WO 2019/012028 A1 being intended to be incorporated in full herein. This document describes a light guide which is embodied such that the outcoupling is implemented after a fixed number of reflections in the light guide and that the outcoupling angular spectrum is increased in comparison with the coupling angular spectrum. The light coupled out propagates on to a visibility region and the outcoupling angular spectrum corresponds to the field of view. However, the propagation and outcoupling of light should not be restricted to these options.

By contrast, FIG. 9 shows the generation of images of the SLM as segments by means of a display apparatus according to the invention. This display apparatus of FIG. 9 can also be embodied as an AR display apparatus in particular, for example an AR head-mounted display or else an AR head-up display. Like the display apparatuses of FIGS. 2 to 7, too, this display apparatus can generate the virtual information in a holographic or a stereoscopic way and represent these in the field of view of a user.

Illustration a) shows the display apparatus when generating a first image of an SLM as a segment and illustration b) of FIG. 9 shows a generation of a second image of an SLM as a segment. The display apparatus of FIG. 9 comprises an illumination device 70, an SLM 71, a combiner 72, a deflection device 73 and at least one imaging element 74 of an optical system.

Now, in contrast to FIG. 8, the SLM 71 only has a relatively small number of pixels here, for example less than 1000 pixels in one direction. To deflect the incident light, the deflection device 73 comprises a scanning mirror element 73-1 here, which is mounted in movable and hence rotatable fashion. The scanning mirror element 73-1 is arranged in the vicinity of a light coupling surface of the combiner 72 so that coupling can be implemented with high accuracy.

In this case, the optical system of the display apparatus should be represented by the imaging element 74, the combiner 72 and the deflection device 73, where naturally a plurality of imaging elements or other optical elements could also be provided. The imaging element 74 is provided in the beam path between the SLM 71 and the deflection device 73. In this exemplary embodiment, the combiner 72 is embodied as a light guide which can have a plane or flat, or else curved embodiment. Further, provision is made of a control device 75, which is coupled to the illumination device 70 and the deflection device 73, in particular the scanning mirror element 73-1. Additionally, it can also be coupled to the SLM 71, where the SLM 71 itself can also be operated by way of its own control device.

If the illumination device 70 now is in an ON state as a result of control by means of the control device 75, the former emits light to the SLM 71, this light is modulated by the SLM 71 and is incident on the deflection device 73 by the imaging element 74. As is evident from the two illustrations a) and b) in FIG. 9, the imaging element 74 generates an coupling angular spectrum of the light which, in terms of its extent, is smaller than the coupling angular spectrum of the light as per FIG. 8. Then, this coupling angular spectrum is coupled into the combiner 72 embodied as a light guide, for example by means of a coupling device which may comprise, for example, a mirror element or else at least one grating element, for example a volume grating. Outcoupling of the light from the combiner 72 can be implemented by way of an outcoupling device 77 which comprises at least one outcoupling element, for example an outcoupling grating element such as a volume grating, and so the light coupled out is directed at an observer plane 78 in the direction of a user B and forms a virtual visibility region 79 in said plane, by means of which the user B can then observe the generated virtual information in the field of view.

1. A display apparatus comprising:
an illumination device for emitting light,
a spatial light modulation device for modulating incident light,
an optical system for generating at least one image of the spatial light modulation device as a segment, where the optical system comprises a deflection device for directing the image of the spatial light modulation device to a defined position in the field of view of a user, and
a control device which is coupled to the illumination device and the deflection device, and embodied to switch the illumination device on the basis of a control of the deflection device.

2. The display apparatus as claimed in claim 1, wherein the optical system is provided for generating at least two images of the spatial light modulation device and for generating virtual visibility regions in accordance with the number of images of the spatial light modulation device, where the at least two images of the spatial light modulation device as segments are present in the field of view.

3. The display apparatus as claimed in claim 2, wherein the at least two images of the spatial light modulation device as segments in the field of view are combined with one another and/or partly overlap one another or are spaced apart from one another by way of a gap.

4. The display apparatus as claimed in claim 1, wherein the number of images of the spatial light modulation device as segments is settable differently between a minimum value and a maximum value in each frame and the position of the images of the spatial light modulation device as segments in the field of view is settable differently in each frame.

5. The display apparatus as claimed in claim 4, wherein the determination of the number and position of the images of the spatial light modulation device as segments in the field of view is dependent on physical surroundings of a user.

6. The display apparatus as claimed in claim 1, wherein the at least one image of the spatial light modulation device is an imaging of the entire spatial light modulation device or an imaging of only a portion of the spatial light modulation device.

7. The display apparatus as claimed in claim 1, wherein the deflection device comprises at least one scanning mirror element which is movably mounted and/or at least one grating element.

8. The display apparatus as claimed in claim 1, wherein any one of the preceding claims, characterized in that the optical system comprises at least one combiner for superimposing virtual information on real information in the field of view.

9. The display apparatus as claimed in claim 1, wherein the deflection device is arranged between the spatial light modulation device and the combiner or between the illumination device and the spatial light modulation device.

10. The display apparatus as claimed in claim 1, wherein the deflection device comprises two scanning mirror elements which are rotatable in a manner synchronized to one another.

11. The display apparatus as claimed in claim 8, wherein the at least one combiner comprises at least one focusing element or at least one focusing function.

12. The display apparatus as claimed in claim 11, wherein the at least one focusing element is embodied as a grating element, in particular as a volume grating, in particular as a grating element with a limited acceptance angle.

13. The display apparatus as claimed in claim 8, wherein the at least one combiner is at least partly curved.

14. The display apparatus as claimed in claim 7, wherein a continuous movement of the at least one scanning mirror element or stepwise movement of the at least one scanning mirror element with a fixedly defined increment is provided in the deflection device.

15. The display apparatus as claimed in claim 14, wherein in the case of a continuous movement of the at least one scanning mirror element, the at least one scanning mirror element is combined with a compensation mirror element which carries out such a synchronized movement with the movement of the at least one scanning mirror element that, in the case of a movement of the two mirror elements in the same sense, an image of the spatial light modulation device is generable at a fixed unchanging position and, in the case of a movement of the two mirror element in the opposite sense, an image of the spatial light modulation device is displaceable in the field of view.

16. The display apparatus as claimed in claim 15, wherein a movement of the scanning mirror element and of the compensation mirror element in the same sense is provided for as long as the illumination device is in an ON state.

17. The display apparatus as claimed in claim 7, wherein a continuous movement of the at least one scanning mirror element with different predefined speeds or a stepwise movement of the at least one scanning mirror element with different adaptable increments is provided for of generating at least two images of the spatial light modulation device as segments in the field of view within a frame.

18. The display apparatus as claimed in claim 17, wherein the speed or the increment of the movement of the at least one scanning mirror element is adapted to the defined position of the respective image of the spatial light modulation device as segment in the field of view.

19. The display apparatus as claimed in claim 1, wherein the size and/or shape of the at least one image of the spatial light modulation device as a segment is variable in successive frames or the size and/or shape of the at least two images of the spatial light modulation device as segments with the defined position in the field of view is variable within a frame or in successive frames.

20. The display apparatus as claimed in claim 8, wherein that the at least one combiner is embodied as a partly reflecting mirror element or as a light guide.

21. The display apparatus as claimed in claim 20, wherein the deflection device is embodied as a switchable coupling element for coupling the light into the combiner embodied as a light guide and/or as an outcoupling element for coupling the light out of the combiner embodied as a light guide.

22. The display apparatus as claimed in claim 1, wherein the optical system comprises a variable focus system which is capable of setting the distance of the at least one image of the spatial light modulation device as a segment in the field of view from the user.

23. The display apparatus as claimed in claim 22, wherein the variable focus system comprises at least one grating element with a controllable grating period or a combination of active and passive imaging elements.

24. The display apparatus as claimed in claim 23, wherein the at least one grating element with a controllable grating period has prism functions and/or phase functions for correcting aberrations.

25. The display apparatus as claimed in claim 1, further comprising a gaze tracking system for detecting a viewing direction of the user and/or a detection device for determining the region of the field of view in which virtual information should be represented.

26. The display apparatus as claimed in claim 1, wherein the illumination device comprises at least one light source that is controllable in pulsed fashion.

27. The display apparatus as claimed in claim 1, wherein the display apparatus is embodied as an augmented reality display for combining physical surroundings and represented virtual information.

28. A method comprising:
controlling a control device which is coupled to an illumination device for emitting light and to a deflection device of an optical system of a display apparatus, for operating the illumination device on the basis of a control of the deflection device in order to direct at least one image of a spatial light modulation device as segment to a defined position in the field of view of a user,
directing the light at the spatial light modulation device and generating at least one image of the spatial light modulation device as a segment by the optical system,
directing the image of the spatial light modulation device as a segment by the deflection device to the defined position in the field of view of the user, and
representing virtual information in the segment in the field of view of the user.

29. The method as claimed in claim 28, wherein the optical system generates at least two images of the spatial light modulation device and virtual visibility regions in accordance with the number of images of the spatial light modulation device, where the at least two images of the spatial light modulation device are formed as segments in the field of view of the user.

30. The method as claimed in claim 28, wherein at least one combiner of the optical system superimposes virtual information additionally generated in the field of view by displaying the at least one image of the spatial light modulation device as a segment on real information in the field of view.

31. The method as claimed in claim 28, wherein the at least one image of the light modulation device as a segment is generated in accordance with a required position in the field of view.

32. The method as claimed in claim 28, wherein the field of view is subdivided into grid fields, where a check is carried out for each frame in respect of in which grid field of the field of view virtual information should be represented, where the spatial light modulation device and at least one scanning mirror element of the deflection device are controlled in such a way that an image of the spatial light modulation device as a segment is generated, in each case only for the grid field in which the virtual information should be represented for each frame, and directed at the defined position in the field of view.

33. The method as claimed in claim 28, wherein the field of view is subdivided into grid fields, where each grid field is scanned in succession by at least one scanning mirror element of the deflection device, where a check is carried out for each frame in respect of in which grid field of the field of view virtual information should be represented and a virtual information-containing image of the spatial light modulation device as a segment is generated and assigned by the optical system only to the respective grid field in which the virtual information should also be represented.

34. The method as claimed in claim 32, wherein the at least one scanning mirror element is moved continuously or stepwise with a defined increment for directing the at least one image of the spatial light modulation device as a segment to a defined position in the field of view.

35. The method as claimed in claim 34, wherein, in the case of a stepwise movement of the at least one scanning mirror element, the illumination device is activated in each case when the at least one scanning mirror element is in a holding state following a defined increment and the spatial light modulation device is illuminated for generating an image of the spatial light modulation device, as a result of which the generated image of the spatial light modulation device as a segment is directed at a defined position in the field of view, where the illumination device is deactivated when the at least one scanning mirror element is in a movement state.

36. The method as claimed in claim 34, wherein, in the case of a continuous movement of the at least one scanning mirror element, a compensation mirror element is combined with the at least one scanning mirror element, where the compensation mirror element carries out a movement that is synchronized with the at least one scanning mirror element when the illumination device is in an ON state.

37. The method as claimed in claim 30, wherein the spatial light modulation device is illuminated by the illumination device and the light modulated by the spatial light modulation device is directed at the deflection device which deflects the light on a combiner that is embodied as a light guide, where the light is coupled into the combiner and propagates in the latter, where the light propagating in the combiner is coupled out in accordance with the required defined position in the field of view and the at least one image of the spatial light modulation device as a segment is directed at this defined position.

38. The method as claimed in claim 28, wherein the at least one image of the spatial light modulation device as a segment is displaced by a variable focus system in the z-direction along an optical axis of the optical system to a depth position in the field of view, at which a user accommodates.
